(19) United States
(12) Patent Application Publication
(10) Pub. No.: US 2011/0115829 A1
(43) Pub. Date: May 19, 2011

(54) IMAGE DISPLAY APPARATUS AND CONTROL APPARATUS THEREOF

(75) Inventors: Takeshi ITO, Osaka (JP); Haruo YAMASHITA, Osaka (JP)

(73) Assignee: PANASONIC CORPORATION, Osaka (JP)

(21) Appl. No.: 12/832,785

(22) Filed: Jul. 8, 2010

(30) Foreign Application Priority Data
Jul. 9, 2009 (JP) 2009-162629

(51) Int. Cl. G09G 5/10

(52) U.S. Cl. 345/690

(57) ABSTRACT

The present invention relates to an image display apparatus that can display high-quality images, and its controlling apparatus. A backlight section (20) has a plurality of light sources which are disposed such that a plurality of light emitting areas are formed, and in which a light emission brightness value is controlled per light emitting area. A liquid crystal panel (10) displays an image by modulating light from the backlight section (20) according to an input image signal. A brightness estimating section (42) acquires an arriving light brightness signal indicating a brightness value of light arriving at a pixel of interest in the liquid crystal panel (10). An image correcting section (44) corrects the modulation factor corresponding to the brightness value of the input image signal for the pixel of interest, based on the acquired arriving light brightness signal and input image signals for the pixel of interest and surrounding pixels of the pixel of interest.

### CROSS REFERENCE TO RELATED APPLICATIONS

This application is entitled to or claims the benefit of Japanese Patent Application No. 2009-162629, filed on Jul. 9, 2009, the disclosure of which including the specification, drawings and abstract, is incorporated herein by reference in its entirety.

### TECHNICAL FIELD

The technical field relates to an image display apparatus, and its controlling apparatus.

### BACKGROUND ART

Recently, a liquid crystal display apparatus that can display images of still images and motion images are rapidly spreading thanks to cost reduced by advancement in manufacturing technology, reduction in the thickness and weight of the liquid crystal display apparatus, and advancement in a technique for providing high-quality images in display functions. A liquid crystal display apparatus is widely used in, for example, a personal computer (PC) monitor and a digital TV that receives and displays digital broadcasting waves.

As the above liquid crystal display apparatus, there are mainly a reflection-type liquid crystal display apparatus and a transmission-type liquid crystal display apparatus. Among these two, the transmission type liquid crystal display apparatus is generally used widely. This transmission type liquid crystal display apparatus has a planar light source that is referred to as a “backlight” formed with, for example, a cold cathode fluorescent tube, and, in the liquid crystal panel, spatially modulates the light radiated from the planar light source and displays desired images.

In case where, for example, desired images are dark images, the above conventional liquid crystal display apparatus expresses dark images by adjusting a brightness signal of light in the liquid crystal panel, and does not adjust the brightness in the backlight. Therefore, even in case of these dark images, the backlight emits light at the maximum brightness, and therefore there is a problem of high power consumption. Further, the brightness signal in light of the liquid crystal panel does not become completely zero, and therefore a phenomenon referred to as “impure black” that light from the backlight leaks and is displayed white in images of dark scenes occur.

By contrast with this, a technique of changing the brightness of the backlight locally by segmenting the screen using light sources such as LEDs is being proposed. Patent Literature 1 discloses a technique of using in an area the amount of light coming from light sources of other areas. Further, Patent Literature 2 discloses a configuration calculating a brightness distribution between backlight areas using an approximate function. Furthermore, Patent Literature 3 discloses correcting the gradation according to brightness levels of light sources of other areas.

### CITATION LIST

### Patent Literature

PTL 1: Japanese Patent Application Laid-Open No. 2007-034251
PTL 2: Japanese Patent Application Laid-Open No. 2005-258403
PTL 3: Japanese Patent Application Laid-Open No. 2002-99250

### SUMMARY

### Technical Problem

By the way, in case where the technique of changing the brightness of the backlight locally by segmenting the screen using light sources such as light emitting diodes (LEDs) is employed, performing control to maintain the brightness for displaying an image at the same brightness as an image signal is not possible unless the brightness value of every pixel is learned. Further, the brightness value of each pixel cannot be learned without taking into account the amount of light coming from light sources of other areas per pixel.

The object is to provide an image display apparatus that can display high-quality images, and its controlling apparatus.

### Solution to Problem

In order to achieve the above object, the image display apparatus includes: a light source which has a plurality of light sources disposed such that a plurality of light emitting areas are formed and in which a light emission brightness value is controlled per each light emitting area; a display section which displays an image by modulating light from the light source section according to a modulation factor corresponding to a brightness value of an input image signal; an acquiring section which acquires an arriving light brightness signal indicating a brightness value of light arriving at a pixel of interest in the display section; and a controlling section which controls the image display apparatus, and the controlling section calculates a modulation factor corresponding to a brightness value of an input image signal for the pixel of interest, based on input image signals for the pixel of interest and surrounding pixels of the pixel of interest and the acquired arriving light brightness signal.

Further, in order to achieve the above object, the controlling apparatus that controls an image display apparatus which displays an image by modulating light from a light source section which has a plurality of light sources disposed such that a plurality of light emitting areas are formed and in which a light emission brightness value is controlled per light emitting area, according to a modulation factor corresponding to a brightness value of an input image signal, includes: an acquiring section which acquires an arriving light brightness signal indicating a brightness value of light arriving at a pixel of interest in the display section; and a controlling section which calculates a modulation factor corresponding to the brightness value of the input image signal for the pixel of interest, based on input image signals for the pixel of interest and surrounding pixels of the pixel of interest and the acquired arriving light brightness signal.

### Advantageous Effects

This apparatus can display high-quality images.

### BRIEF DESCRIPTION OF DRAWINGS

FIG. 1 is a schematic diagram showing a liquid crystal display apparatus according to Embodiment 1 of the present invention;

FIG. 2 shows a specific configuration of a backlight section according to Embodiment 1 of the present invention;

FIG. 3 is a schematic diagram showing a specific configuration of a controlling section according to Embodiment 1 of the present invention;

FIG. 4 is a schematic diagram showing a specific configuration of a signal correcting section according to Embodiment 1 of the present invention;

FIG. 5 is a schematic diagram showing a specific configuration of a peak brightness signal calculating section according to Embodiment 1 of the present invention;

FIG. 6 shows brightness values (i.e. input brightness values) of image brightness signals according to Embodiment 1 of the present invention;

FIG. 7 shows a brightness value (i.e. first maximum brightness value) of a first maximum brightness signal according to Embodiment 1 of the present invention;

FIG. 8 is a schematic diagram for illustrating a segmenting operation in a subblock segmenting section according to Embodiment 1 of the present invention;

FIG. 9 shows an example of calculation of a brightness value (i.e. second maximum brightness value) of a second maximum brightness signal according to Embodiment 1 of the present invention;

FIG. 10 illustrates interpolating processing in an interpolating section according to Embodiment 1 of the present invention;

FIG. 11A is a conceptual diagram for illustrating a first example of a correcting operation in a brightness signal correcting section according to Embodiment 1 of the present invention;

FIG. 11B illustrates a second example of a correcting operation in a brightness signal correcting section according to Embodiment 1 of the present invention;

FIG. 12 is a perspective view showing a light emitting area according to Embodiment 1 of the present invention, from a horizontal direction;

FIG. 13 illustrates a specific correcting method in a brightness signal correcting section according to Embodiment 1 of the present invention;

FIG. 14 shows the relationship between a brightness value (i.e. input brightness value) of an image brightness signal and an actual brightness value (i.e. display brightness value) in a pixel of a liquid crystal panel, according to Embodiment 1 of the present invention;

FIG. 15 is a schematic diagram showing a configuration of an image correcting section according to Embodiment 2 of the present invention;

FIG. 16 is a schematic diagram showing a specific configuration of an average brightness signal calculating section according to Embodiment 2 of the present invention;

FIG. 17 illustrates a method of calculating an average peak brightness value based on a peak brightness value of each pixel, according to Embodiment 2 of the present invention;

FIG. 18 shows the relationship between an average value and a change ratio according to Embodiment 2 of the present invention;

FIG. 19 illustrates a specific correcting method in a brightness signal correcting section according to Embodiment 2 the present invention;

FIG. 20 shows the relationship between a brightness value (i.e. input brightness value) of an image brightness signal and an actual brightness value (i.e. display brightness value) in a pixel of a liquid crystal panel, according to Embodiment 2 of the present invention;

FIG. 21 shows a configuration of an image correcting section according to Embodiment 3 of the present invention;

FIG. 22 shows a configuration in which a reflecting plate is provided in a backlight section, according to another embodiment of the present invention;

FIG. 23 shows a configuration of a controlling section that can control red, green and blue independently in a backlight section, according to another embodiment of the present invention; and

FIG. 24 shows a specific configuration of an image correcting section shown in FIG. 23.

### DESCRIPTION OF EMBODIMENTS

### Content

### 1. Embodiment 1 of the Present Invention

### 1-1 Configuration of Liquid Crystal Display Apparatus

### 1-1-1. Liquid Crystal Panel

### 1-1-2. Backlight Section

### 1-1-3. Backlight Driver

### 1-1-4. Controlling Section

### 1-1-4-1. Backlight Controlling Section

### 1-1-4-2. Brightness Estimating Section

### 1-1-4-3. Signal Correcting Section

### 1-1-4-4. Image Correcting Section

### 1-1-4-4-1. Peak Brightness Signal Calculating Section

### 1-1-4-4-1-1. First Brightness Signal Controlling Section

### 1-1-4-4-1-2. First Memory

### 1-1-4-4-1-3. Second Brightness Signal Controlling Section

### 1-1-4-4-1-3-1. Method of Segmenting Light Emitting Area

### 1-1-4-4-1-3-2. Method of Generating Brightness Signals Corresponding to Subblocks

### 1-1-4-4-1-4. Second Memory

### 1-1-4-4-1-5. Brightness Signal Filter Section

### 1-1-4-4-1-6. Interpolating Section

### 1-1-4-4-2. Brightness Signal Correcting Section

### 1-1-4-4-2-1. Specific Correcting Method in Brightness Signal Correcting Section

### 1-2. Conclusion

### 2. Embodiment 2

2-1. Image correcting section

### 2-1-1. Average Brightness Signal Calculating Section

### 2-1-1-1. Average Value Filter Section

### 2-1-1-1-1. Method of Calculating Average Value Dave

### 2-1-2. Change Ratio Determining Section

### 2-1-2-1. Operation in Change Ratio Determining Section

### 2-1-3. Brightness Signal Correcting Section

### 2-1-3-1. Correcting Method in Brightness Signal Correcting Section

### 2-2. Conclusion

### 3. Embodiment 3

### 4. Another Embodiment

Hereinafter, the best embodiments for carrying out the present invention will be explained with reference to the accompanying drawings.

### Embodiment 1

Hereinafter, Embodiment 1 of the present invention will be explained with reference to the accompanying drawings.

<1-1. Configuration of Liquid Crystal Display Apparatus>

First, a configuration of a liquid crystal display apparatus will be explained.

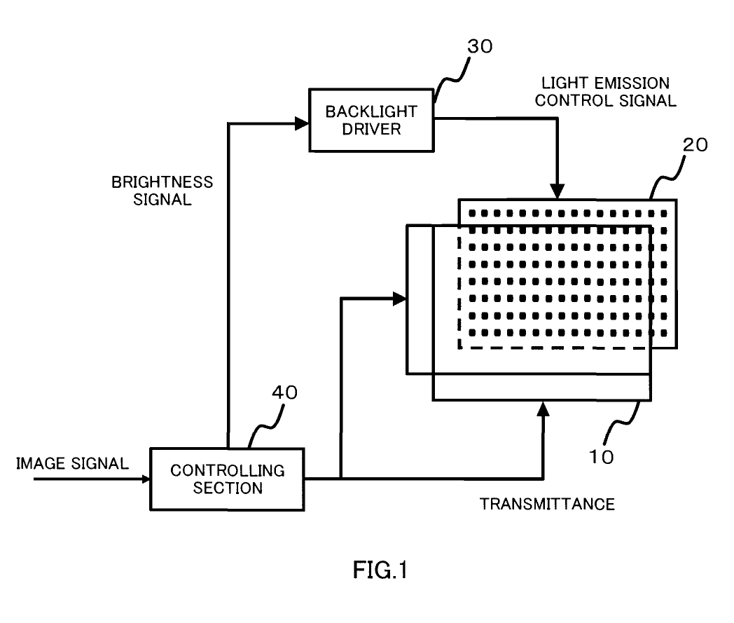

FIG. 1 is a schematic diagram showing a liquid crystal display apparatus according to Embodiment 1 of the present invention.

Liquid crystal display apparatus 1 has liquid crystal panel 10, backlight section 20, backlight driver 30 and controlling section 40. Hereinafter, the configuration of each section will be explained in detail.

<1-1-1. Liquid Crystal Panel>

Liquid crystal panel 10 as a displaying section displays an image by modulating illumination light radiated on the back surface of liquid crystal panel 10 by backlight section 20, according to an image signal received as input from controlling section 40.

Further, liquid crystal panel 10 employs a configuration in which a liquid crystal layer is sandwiched between glass substrates, and a signal voltage is applied to the liquid crystal layer meeting each pixel by the gate driver (not shown) and source driver (not shown), and the transmittance is controlled. Liquid crystal panel 10 generates a control signal for controlling the transmittance in a pixel, based on the transmittance received as input from controlling section 40 in the gate driver and the source driver provided in liquid crystal panel 10.

Further, liquid crystal panel 10 uses the IPS (In-Plane Switching) scheme. Liquid crystal molecules make a simple motion of rotating in parallel with the glass substrate, so that the IPS scheme provides a wide view angle, and has characteristics that change in color hue depending on viewing directions is little and change in color hue in full tonal gradation is little.

Note that liquid crystal panel 10 may be any device as long as it performs optical modulation, and, for example, the VA (Vertical Alignment) scheme may be employed as another optical modulation scheme.

That is, liquid crystal panel 10 is a type of a non-self-luminous display device, and it is equally possible to substitute a non-self-luminous display device of another type for a display section of the present invention. Hence, the image display apparatus according to the present invention is not limited to the liquid crystal display apparatus. Further, the transmittance is an optical modulation factor which is used in case where the display device is a liquid crystal panel and which is determined according to an image signal of each pixel, and therefore other optical modulation factors are used in case where the display device is not a liquid crystal panel.

<1-1-2. Backlight Section>

Backlight section 20 as a light source section is a device that radiates illumination light for displaying an image, on the back surface of liquid crystal panel 10.

Backlight section 20 has a plurality of light sources 21. Based on a light emission control signal outputted from backlight driver 30, backlight section 20 controls as a base unit a light emitting area that adopts at least one or more light sources 21 as a unit. Each light emitting area is provided to face each image display area of liquid crystal panel 10 and mainly illuminates the facing image display area. Here, the word “mainly” suggests that each light emitting area may radiate part of its illuminating light on image display areas that the light emitting area does not face.

Note that, to make light radiated from light emitting areas uniform, a diffusing sheet may be provided between liquid crystal panel 10 and backlight section 20.

Here, light source 21 uses an LED that emits white light. Note that light source 21 is not limited to a light source that directly emits white light. For example, light source 21 may emit white light by blending, for example, red, green and blue lights. Further, light sources of other types may be used instead of LEDs. These light sources can adopt, for example, semiconductor laser light sources or organic EL light sources.

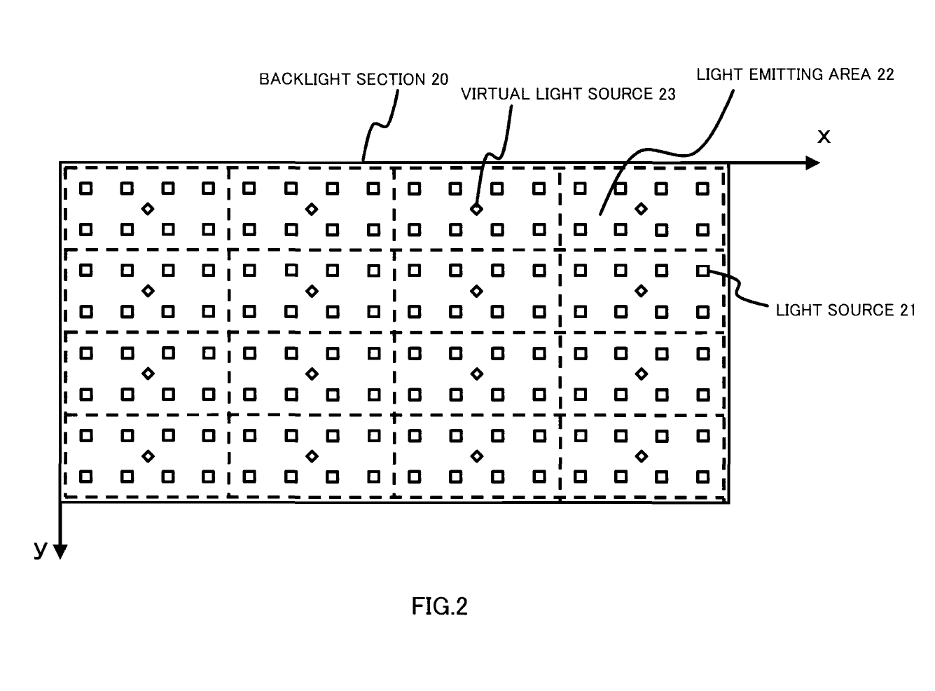

FIG. 2 shows a specific configuration of backlight section 20.

Backlight section 20 is a direct type backlight apparatus having characteristics that a plurality of light sources 21 are uniformly aligned on the surface facing the back surface of liquid crystal panel 10. Further, backlight section 20 has light emitting areas 22 which adopt eight light sources 21 as one unit. These light sources 21 employ a configuration provided with a diffusing plate such that light emitting areas 22 emit light uniformly. Further, light emitting area 22 has virtual light source 23 that is configured to virtually use eight light sources 21 as one light source. Virtual light source 23 is set in the reference position inside the light emitting area. Further, as shown in FIG. 2, backlight section 20 has sixteen light emitting areas.

Note that the x axis direction and the y axis direction shown in FIG. 2 correspond to the horizontal direction and the vertical direction, respectively, in the display screen of liquid crystal panel 10, and therefore, in the following explanation, the x axis direction and the y axis direction will be referred to as “the horizontal direction” and “the vertical direction,” respectively.

Controlling section 40 controls light emitting area 22 by controlling this virtual light source 23. Although the position to arrange virtual light source 23, that is, the reference position inside light emitting area 22, is the center portion of light emitting area 22 with the example shown in FIG. 2, in case where eight light sources 21 are controlled simultaneously, any arrangement is possible as long as these light sources 21 can emit light uniformly to light emitting area 22. Depending on the degree of diffusion of light of each light source 21 or how each light source 21 is disposed, the reference position inside light emitting area 22 may assume the position off the center of light emitting area 22.

<1-1-3. Backlight Driver>

Backlight driver 30 is a circuit that generates a light emission control signal based on a light emission brightness signal received as input from controlling section 40, and that outputs the generated light emission control signal to backlight section 20. The light emission control signal is a signal for controlling drive of individual light sources 21. Note that backlight driver 30 can be realized by, for example, an electrical circuit.

<1-1-4. Controlling Section>

Controlling section 40 generates a light emission transmittance that defines the transmittance of the liquid crystal layer meeting each pixel of liquid crystal panel 10, based on an image signal received as input (simply “input image signal”). Further, controlling section 40 generates a brightness signal that defines the light emission ratio for each of individual light emitting areas provided in backlight section 20. This brightness signal is a signal for controlling the light emission brightness value of backlight section 20 per light emitting area. For ease of explanation, this brightness signal is referred to as “light emission brightness signal.” Controlling section 40 is realized by the combination of a computation processing apparatus (for example, CPU (Central Processing Unit)) and a storing apparatus, and forms the controlling apparatus of the present invention.

With the present embodiment, backlight section 20 is segmented into sixteen as shown in FIG. 2, and therefore controlling section 40 generates sixteen brightness signals per frame of an input signal.

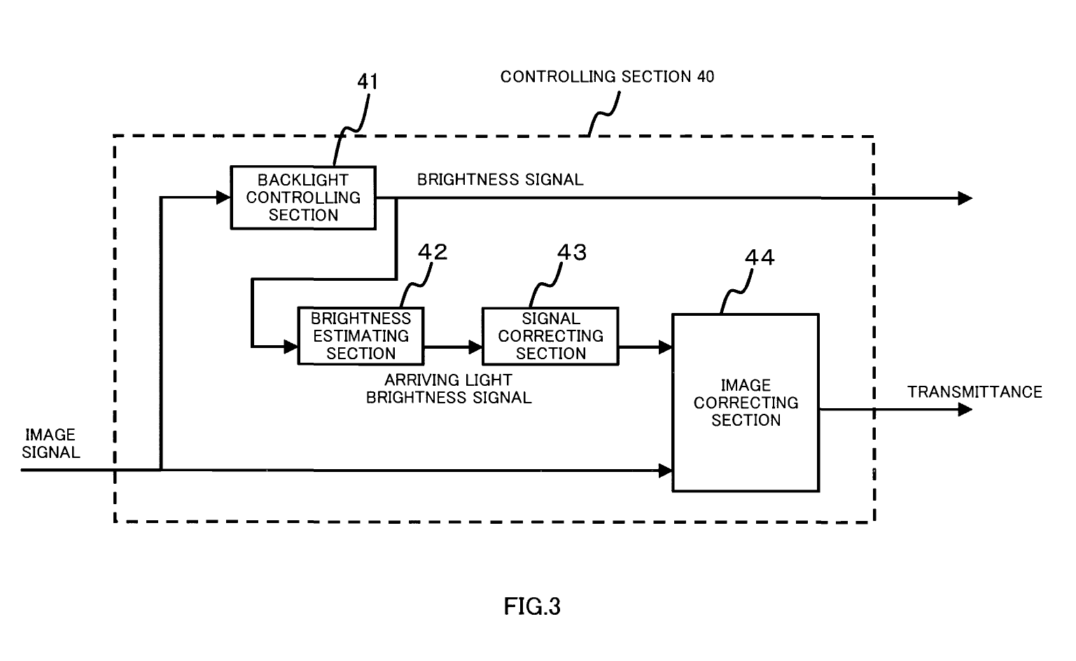

FIG. 3 is a schematic diagram showing a specific configuration of controlling section 40.

Specifically, controlling section 40 has backlight controlling section 41, brightness estimating section 42, signal correcting section 43 and image correcting section 44.

<1-1-4-1. Backlight Controlling Section>

Backlight controlling section 41 as a light source controlling section generates a light emission brightness signal based on an input image signal. Backlight controlling section 41 outputs the generated light emission brightness signal to backlight driver 30 and brightness estimating section 42.

Note that the light emission brightness signal generated in backlight controlling section 41 indicates the rate of the light emission brightness value with respect to the maximum brightness of each virtual light source 23. Note that, for ease of explanation, the rate in case where the non-light emission brightness is set to 0, the maximum brightness is set to 255 and this maximum brightness of 255 is set to 1, is indicated by a brightness signal. For example, if the light emission brightness is 128, the light emission brightness value indicated by the light emission brightness signal is 0.5. Other brightness signals used in the present embodiment indicate brightness values in the same scheme as the light emission brightness signal.

<1-1-4-2. Brightness Estimating Section>

Based on a light emission brightness signal that is received as input from backlight controlling section 41 and that is set per light emitting area, brightness estimating section 42 as an acquiring section estimates an estimation value (hereinafter, “arriving light brightness value”) of the brightness of light arriving at each pixel provided in liquid crystal panel 10, and generates per pixel the arriving light brightness signal indicating the estimated arriving light brightness value. Brightness estimating section 42 outputs an arriving light emission brightness signal to signal correcting section 43.

<1-1-4-3. Signal Correcting Section>

Signal correcting section 43 detects characteristics of an input image signal. Further, signal correcting section 43 converts characteristics of the arriving light brightness value indicated by an arriving light brightness signal received as input from brightness estimating section 42, according to the characteristics of the detected image signal. For example, in case where an input image signal is subjected to gamma conversion, gamma conversion is applied to the arriving light brightness value. With regard to a specific conversion method, a conversion table may be used.

<1-1-4-4. Image Correcting Section>

Based on the arriving light brightness value of each pixel indicated by the arriving light brightness signal received as input from signal correcting section 43 and the brightness value of each pixel indicated by the brightness signal defined by the input image signal, image correcting section 44 corrects the brightness value of the input image signal for the pixel of interest. Here, the transmittance of liquid crystal panel 10 is acquired by dividing the brightness value of the input image signal by the arriving light brightness value, and its minimum value is 0.0 (or 0%) and its maximum value is 1.0 (or 100%). Hence, image correcting section 44 corrects the brightness value of the input image signal of the pixel of interest to substantially correct the transmittance of the pixel of interest. Image correcting section 44 outputs the corrected transmittance.

Here, “pixel of interest” refers to a pixel that is the target to be processed in, for example, controlling section 40. Further, for ease of explanation, the brightness signal defined by the input image signal is referred to as “image brightness signal.” Furthermore, the brightness value indicated by the image brightness signal is referred to as “input brightness value.”

Here, a case is assumed where the brightness is controlled per light emitting area in backlight section 20. In this case, even if signals inputted in liquid crystal panel 10 and backlight section 20 are generated based on the same image signal, the difference in brightness between display images is produced due to the difference in brightness between light emitting areas illuminating the display areas of its image. Therefore, there are cases where display images look unnatural. This problem occurs because the input image signal is generated assuming that all light sources in backlight section 20 emit light constantly.

Image correcting section 44 corrects the input brightness value in a pixel defined by the image signal such that a contrast gain of an image to be displayed on liquid crystal panel 10 changes in conjunction with the arriving light brightness value in the pixel that is generated from a light emission brightness signal of a light emitting area. This correction of the transmittance reduces the above difference in brightness in a display image, thereby preventing unnatural images, so that it is possible to display high-quality images.

A specific configuration of image correcting section 44 will be explained with reference to the accompanying drawings.

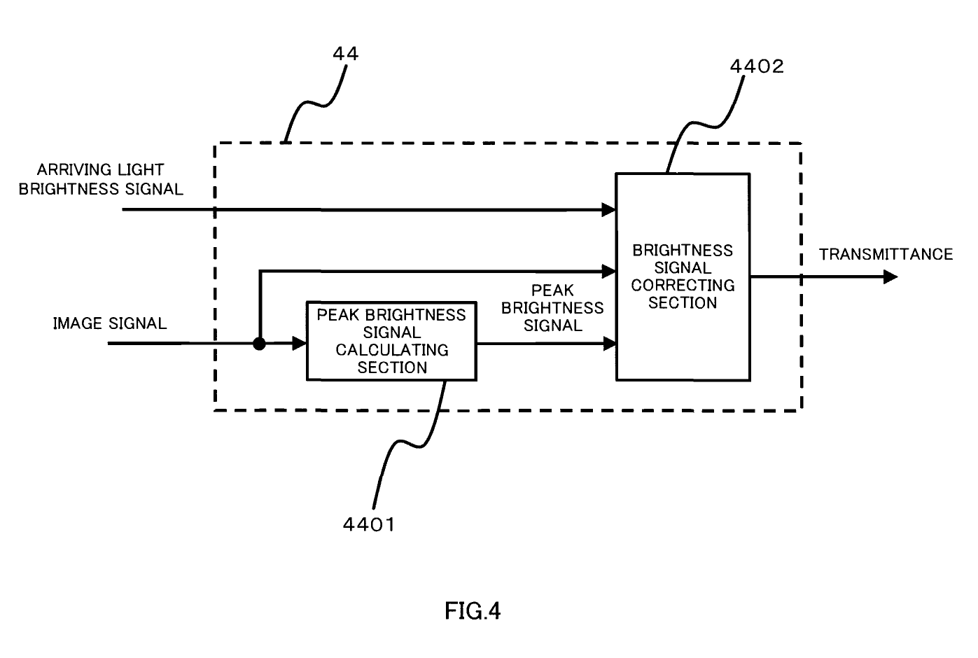

FIG. 4 is a schematic diagram showing a specific configuration of image correcting section 44.

Image correcting section 44 has peak brightness signal calculating section 701 and brightness signal correcting section 702.

<1-1-4-4-1. Peak Brightness Signal Calculating Section>

Peak brightness signal calculating section 4401 calculates peak brightness value Dmax per pixel, based on the maximum brightness value inside a predetermined area among input brightness values of all pixels, and generates per pixel a peak brightness value indicating calculated peak brightness value Dmax. Further, peak brightness signal calculating section 4401 outputs the generated peak brightness signal to brightness signal correcting section 4402.

Note that the above predetermined area may be light emitting areas 22 set in backlight section 20. In this case, if backlight section 20 employs a configuration having sixteen light emitting areas 22, a peak brightness value is calculated based on sixteen maximum brightness values. The following explanation will be made by setting the predetermined area as the light emitting area.

Further, peak brightness signal calculating section 4401 may segment light emitting area 22 set in backlight section 20, into n subblocks, and set the above predetermined area to the subblocks. In this case, if backlight section 20 employs a configuration having sixteen light emitting areas 22, a peak brightness value is calculated based on 16n maximum brightness values.

Further, peak brightness signal calculating section 4401 may perform filter processing using a low pass filter before calculating the peak brightness value.

Furthermore, correction processing may be performed such that peak brightness values between areas change continuously.

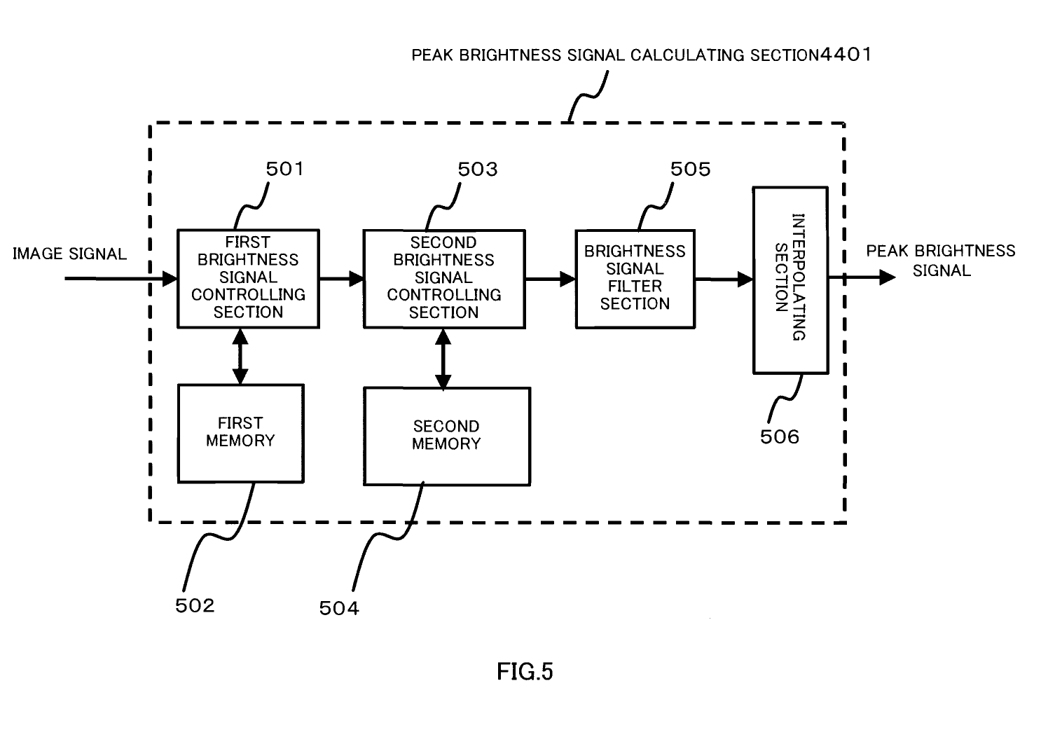

FIG. 5 is a schematic diagram showing a specific configuration of peak brightness signal calculating section 4401. Peak brightness signal calculating section 4401 in FIG. 5 divides the image brightness signal set per pixel in the input image signal, into sixteen areas, and further segments these sixteen areas into sixty four subblocks (i.e. sub areas). Then, peak brightness signal calculating section 4401 performs filter processing of these subblocks, calculates a peak brightness value of each pixel from the result of filter processing, and generates the peak brightness signal indicating the calculated peak brightness value.

Peak brightness signal calculating section 4401 has first brightness signal controlling section 501, first memory 502, second brightness signal controlling section 503, second memory 504, brightness signal filter section 505 and interpolating section 506.

<1-1-4-4-1-1. First Brightness Signal Controlling Section>

First brightness signal controlling section 501 detects the maximum value of the input brightness value per each predetermined area, based on the input brightness value of the image brightness signal set per pixel of the input image signal. For ease of explanation, this maximum brightness value detected per predetermined area is referred to as “first maximum brightness value.” Further, first brightness signal controlling section 501 reads information accumulated in first memory 502 and writes the input brightness value of each pixel and the above first maximum brightness value, and, in addition, outputs the first maximum brightness signal indicating the first maximum brightness value read from first memory 502, to second brightness controlling section 503.

Hereinafter, the operation of first brightness signal controlling section 501 will be explained with reference to the accompanying drawings.

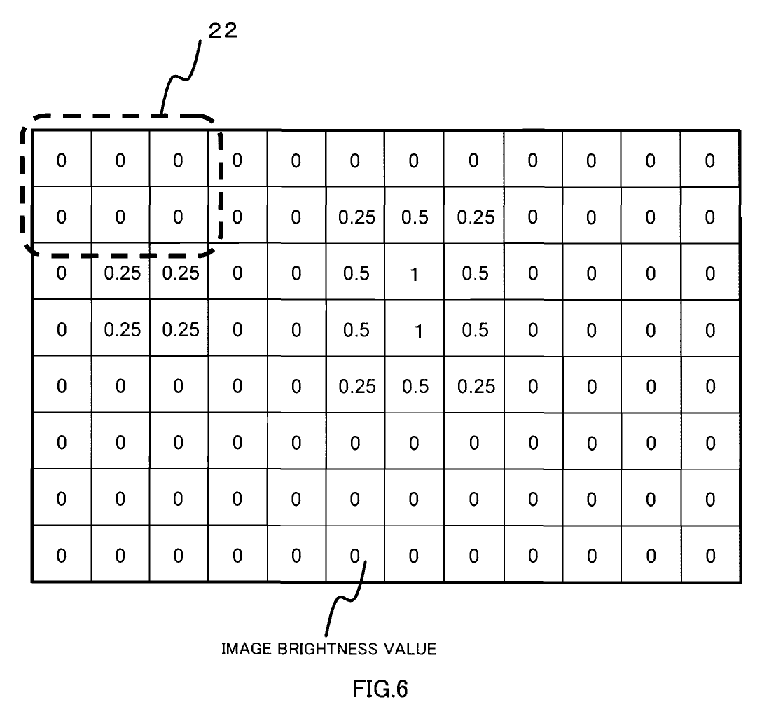

FIG. 6 shows an input brightness value of an image signal of each pixel.

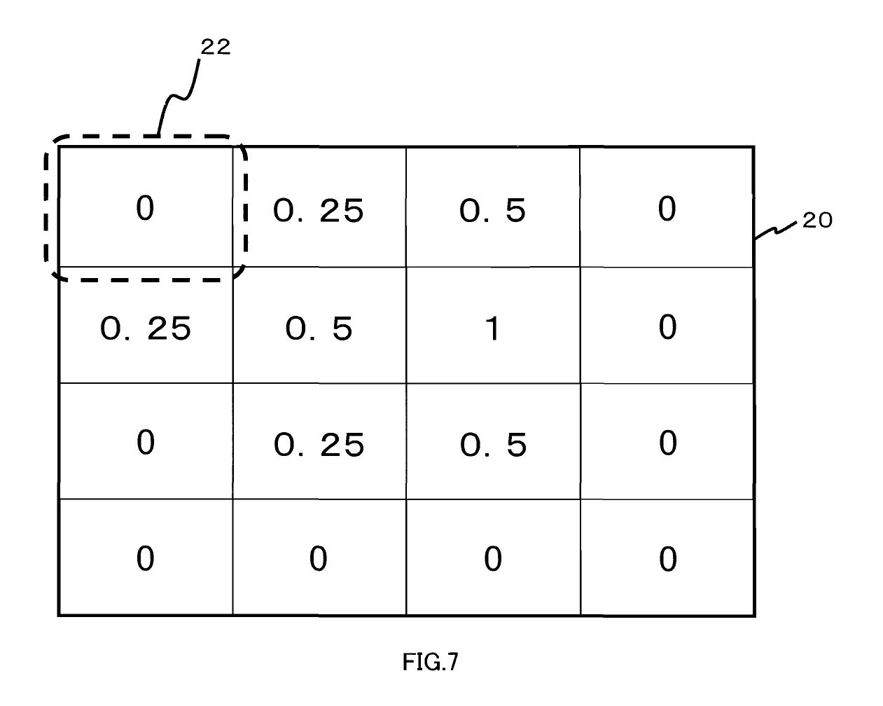

When receiving the input brightness value of each pixel shown in FIG. 6 as input, first brightness signal controlling section 501 detects the maximum value of the input brightness value, that is, first maximum brightness value, per light emitting area 22. By detecting the first maximum brightness value of each light emitting area 22 from the input brightness value of each pixel shown in FIG. 6, it is possible to acquire the matrix related to the brightness values shown in FIG. 7.

Note that the input image signal includes three types of red, green and blue signals. Therefore, when detecting the first maximum brightness value of each light emitting area 22, the maximum value of input brightness values of a red signal, a green signal and a blue signal inside light emitting area 22 is detected as the first maximum brightness value.

<1-1-4-4-1-2. First Memory>

First memory 502 accumulates the input brightness value of each pixel and the first maximum brightness value of each light emitting area.

<1-1-4-4-1-3. Second Brightness Signal Controlling Section>

Based on the first maximum brightness signal of each light emitting area 22 that is received as input from first brightness signal controlling section 501, second brightness signal controlling section 503 segments light emitting area 22 in subblock units and generates a brightness signal per subblock. That is, second brightness signal controlling section 503 segments light emitting area 22 into a plurality of subblocks smaller than this light emitting area 22. For ease of explanation, the brightness signal generated per subblock by second brightness signal controlling section 503 is referred to as “second maximum brightness signal.” Further, the brightness value indicated by the second maximum brightness signal is referred to as “second maximum brightness value.”

Further, second brightness signal controlling section 503 reads information accumulated in second memory 504 and writes the first maximum brightness value of each light emitting area and the second maximum brightness value of each subblock, and outputs the second maximum brightness signal indicating the second maximum brightness value read from second memory 504, to brightness signal filter section 505.

Hereinafter, a method of segmenting areas and a method of generating the second maximum brightness signal in second brightness signal controlling section 503 will be explained.

<1-1-4-4-1-3-1. Method of Segmenting Light Emitting Area>

When segmenting one light emitting area into subblocks, second brightness signal controlling section 503 segments the light emitting area such that subblocks 801 become virtually rectangular. Here, subblocks 801 are made virtually rectangular because a shape that is not strictly a square, such as 1:1.3, is possible. For example, in case where the aspect ratio of light emitting areas 22 is 9:16, second brightness signal controlling section 503 is configured to segment light emitting areas 22 into 144 virtually rectangular subblocks.

By segmenting the light emitting areas into virtually rectangular subblocks, it is possible to use light emitting areas in which light sources 21 are disposed to spread horizontally (for example, four columns and two rows of light sources 21) like light emitting areas in which the same number of light sources 21 are disposed in the horizontal direction and the vertical direction. Consequently, even in case where the degree of diffusion of light of each light source 21, the method of disposing each light source 21 and the number of light sources 21 included in light emitting area 22 change, it is possible to set adequately brightness signals in light emitting areas.

Note that second brightness signal controlling section 503 may segment light emitting areas 22 by the number of light sources 21 included in light emitting areas 22. To be more specific, when it is decided that eight light sources 21 are included in light emitting area 22, second brightness signal controlling section 503 segments this light emitting area into eight subblocks 51. In this case, the light emitting area can be used in the same way control is performed in light source 21 units, so that it is possible to adequately set a second maximum brightness signal in light emitting areas.

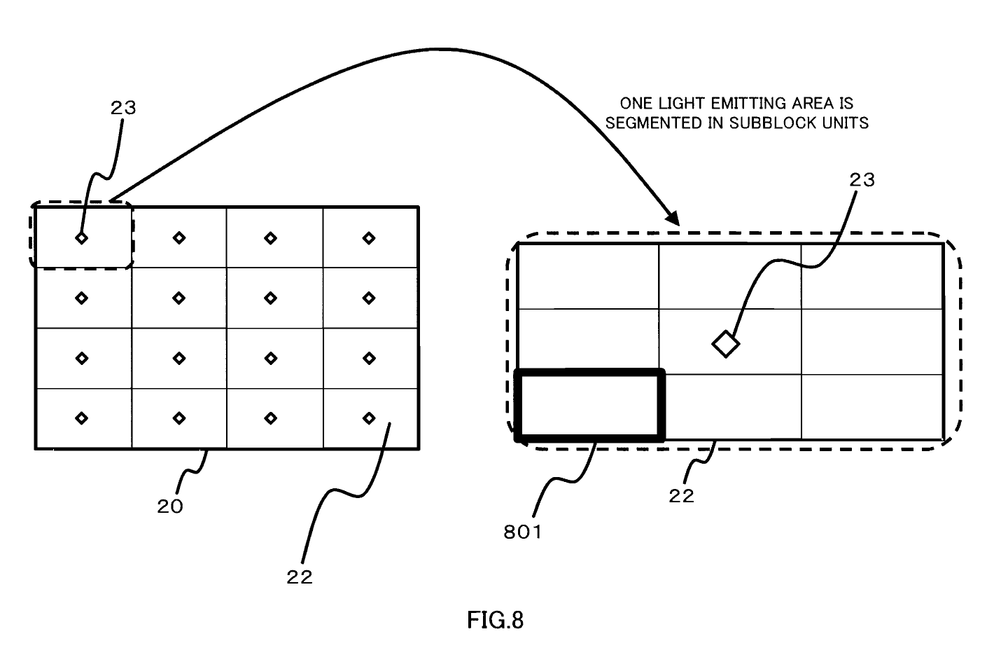

FIG. 8 is a schematic diagram for illustrating the segmenting operation in subblock segmenting section. FIG. 8 shows the operation of segmenting one light emitting area 22 into four subblocks 801.

<1-1-4-4-1-3-2. Method of Generating Brightness Signals Corresponding to Subblocks>

When calculating the maximum brightness value (i.e. second maximum brightness value) of each subblock, second brightness signal controlling section 503 may set the second maximum brightness value for all subblocks inside one light emitting area, to a value equal to the first maximum brightness value of this one light emitting area. For example, in case where the brightness signal of the light emitting area is 0.5, all brightness signals of subblocks inside this light emitting area are set to 0.5.

Note that second brightness signal controlling section 503 may perform filter processing of these subblocks when calculating the second maximum brightness signal per subblock. The filter coefficient for performing filter processing is a value set according to the degree of diffusion of light of each light source 21, the method of disposing each light source 21 and the number of light sources 21 provided in light emitting area 21. Further, in case where a diffusing plate is provided, the filter coefficient may be set based on the light diffusion characteristics of this diffusing plate.

For example, in case where light sources 21 inside light emitting area 21 are disposed to spread horizontally (for example, four columns×two rows of light sources 21), if virtual light source 23 is placed in the center of the light emitting area, the filter coefficient is set such that brightness signals change in a virtually oval pattern around virtual light source 23.

With the above configuration, it is possible to express fine light emission characteristics inside light emitting area 22 and, consequently, calculate brightness signals adequately.

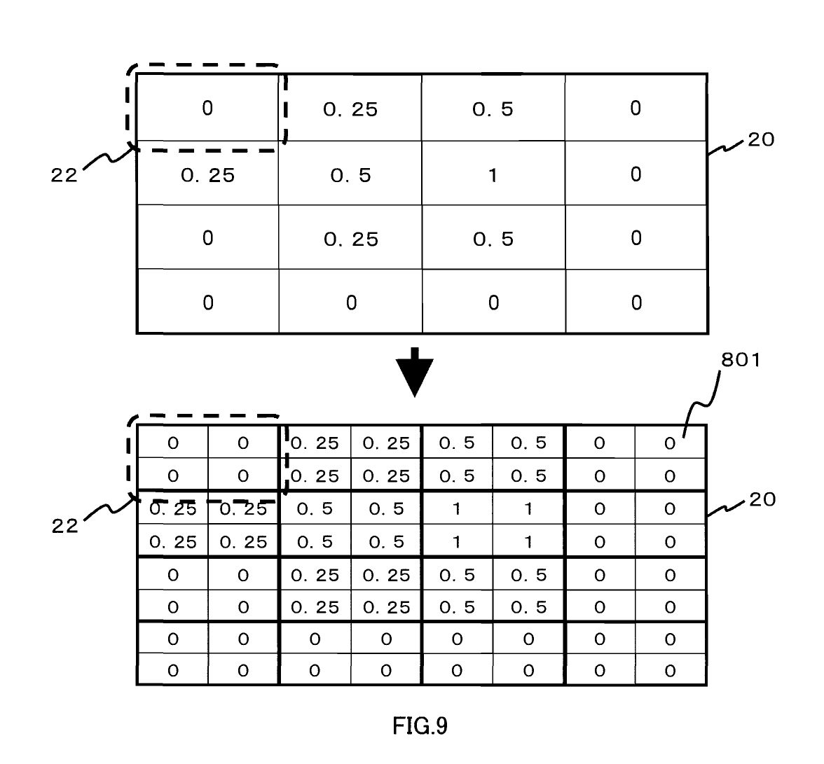

FIG. 9 shows an example of calculation of the second maximum brightness value of each subblock in second maximum brightness signal controlling section 503. With the present embodiment, the first maximum brightness value of each light emitting area shown in FIG. 7 is received as input in second brightness signal controlling section 503.

With the numerical example shown in FIG. 9, second brightness signal controlling section 503 segments one light emitting area 22 into four subblocks 801 first. Further, based on sixteen first maximum brightness signals set per light emitting area 22, sixty four second maximum brightness signals corresponding to subblocks 801 are generated. With the present embodiment, the first maximum brightness value of each light emitting area 22 is used as the second maximum brightness value of subblock 801 corresponding to this light emitting area 22.

<1-1-4-4-1-4. Second Memory>

Second memory 504 accumulates segmentation information (for example, the number of segments of light emitting areas and the segmenting method thereof) received as input from second brightness signal controlling section 503, and the second maximum brightness value of each subblock.

<1-1-4-4-1-5. Brightness Signal Filter Section>

Brightness signal filter section 505 performs filter processing of segmentation information and a second maximum brightness signal of each subblock received as input from second brightness signal controlling section 503. Further, brightness signal filter section 505 outputs a signal indicating the second maximum brightness signal of each subblock acquired from this filter processing, to interpolating section 506.

The filter that performs this filter processing is set as a two-dimensional filter, and has brightness distribution characteristics in virtual light source 23. That is, by performing filter processing of the second maximum brightness value calculated per subblock using this filter, it is possible to convert the brightness value into a brightness value taking into account the influence of virtual light source 23 of interest upon the light emission brightness, and, in addition, the influence of the virtual sources disposed around virtual light source 23 of interest. Here, the influence from virtual light sources disposed around the virtual light source of interest refers to, for example, light leaking from neighboring light emitting areas, and, in case where light sources 21 are LEDs, refers to the influence of light diffusion characteristics of LED lenses.

Note that the filter size may be set according to the number of segments, and set to a size greater than the number of segments. For example, in case where backlight section 20 is segmented into subblocks of eight rows and eight columns, the filter size is set to a size of fifteen rows and fifteen columns.

<1-1-4-4-1-6. Interpolating Section>

Interpolating section 506 calculates a peak brightness value of each pixel, based on the second maximum brightness value of each subblock indicated by the signal that is received as input from brightness signal filter section 505, and generates the peak brightness signal indicating the calculated peak brightness value per pixel. Here, the peak brightness value refers to “peak value” of brightness values in pixels provided in liquid crystal panel 10 that is estimated from the first maximum brightness value of each light emitting area and that is calculated based on an input brightness signal.

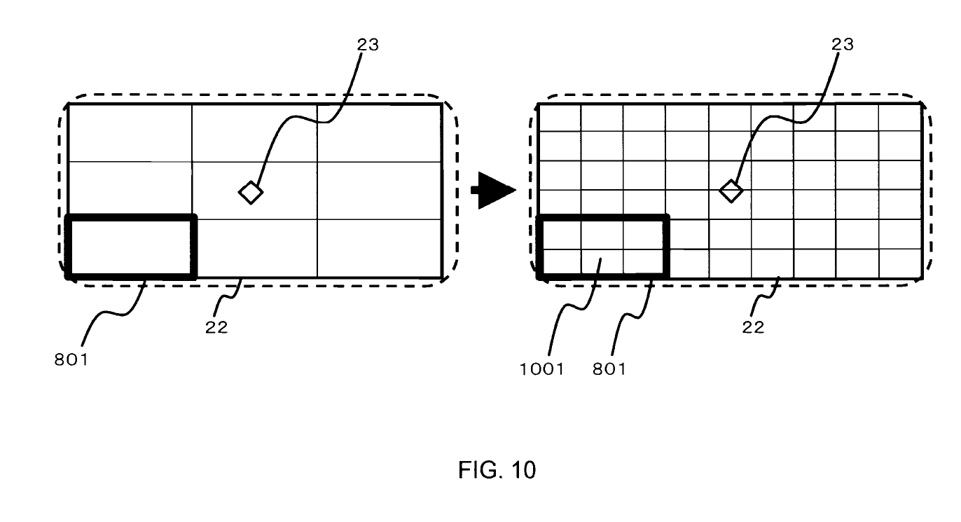

FIG. 10 illustrates interpolation processing in interpolating section 506. FIG. 10 shows that, in light emitting area 22 that is segmented into nine subblocks 801, these subblocks 801 are segmented per pixel 1001. Note that, in FIG. 10, although six pixels 1001 are provided in subblock 801, any number of pixels may be provided in subblock 801.

To be more specific, in case where a second maximum brightness signal of 0.5 is set to subblock 801, interpolating section 506 sets the peak brightness values of all pixels provided in this subblock 801, to 0.5.

Note that the operation is not limited to the above, and interpolation processing that is generally used to calculate a peak brightness value per pixel 1001 may be used. Further, after the peak brightness value is calculated per pixel as described above, filter processing such as lowpass filtering may be performed. By performing filter processing using a lowpass filter after subblocks are segmented per pixel, the characteristics of the brightness to be seen become smooth, so that it is possible to display natural images through a liquid crystal panel. Further, the filter used in the above filter processing is not limited to a lowpass filter, and a filter that is set according to, for example, light emission characteristics in backlight section 20 may be used.

<1-1-4-4-2. Brightness Signal Correcting Section>

Brightness signal correcting section 4402 corrects the input brightness value, based on the arriving light brightness value, the input brightness value and the peak brightness value.

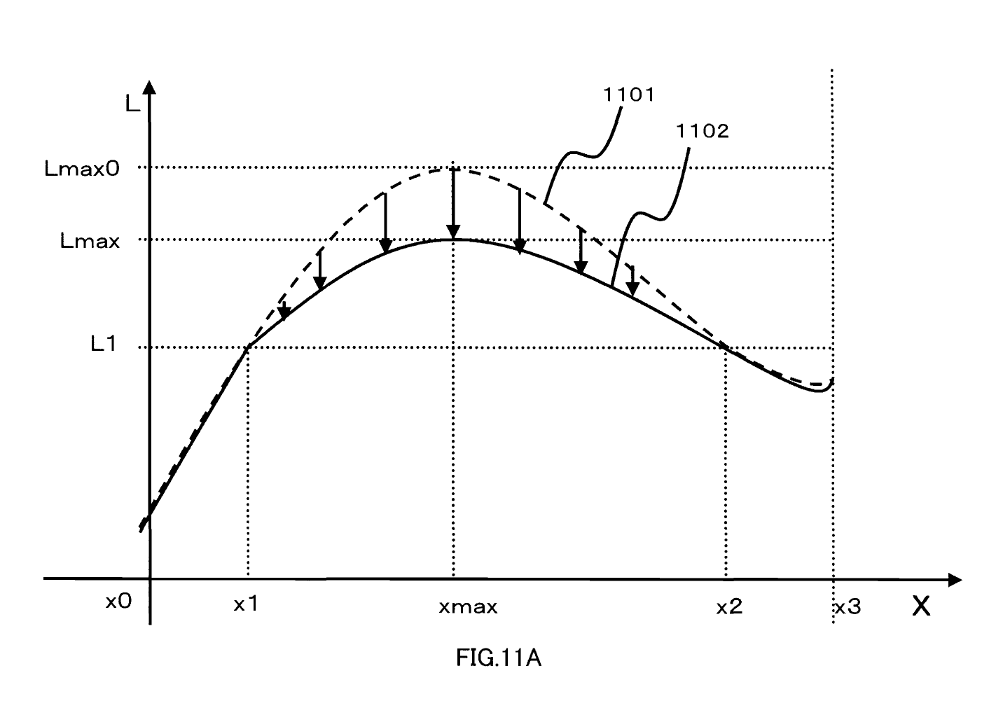

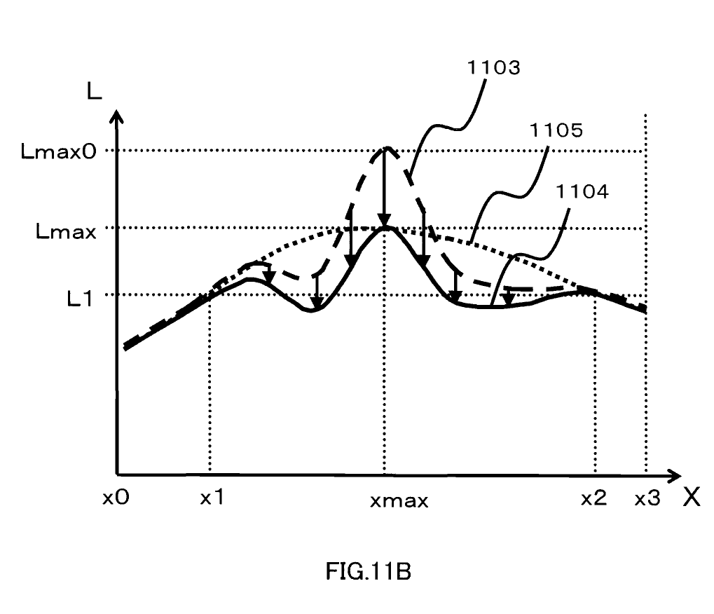

Here, the correcting operation will be explained using two examples with reference to FIG. 11A and FIG. 11B.

FIG. 11A is a conceptual diagram for illustrating the first example of the correcting operation in brightness signal correcting section 4402.

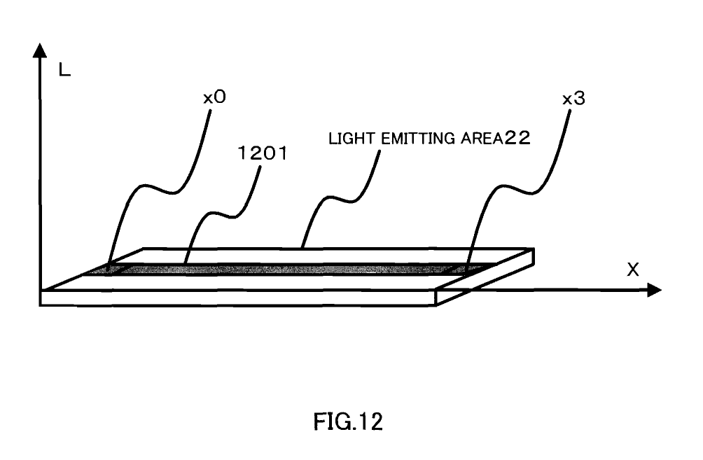

The horizontal axis in FIG. 11A indicates the coordinates of each pixel in case where light emitting area 22 is cut in predetermined row 1201 as shown in FIG. 12. That is, for ease of understanding of the present invention, the correcting operation with respect to this local area will be explained focusing on the area of row 1201 as a local area of backlight section 20. In FIG. 11A, x0 and x3 are the coordinates of the pixel positioned at the end of the light emitting area. Further, the vertical axis in FIG. 11A indicates the brightness value. In FIG. 11A, the arriving light brightness value in the position of xmax is set to Lmax, and the original input brightness value in the position of xmax is set to Lmax0. The same preconditions apply to the example of FIG. 11B (described later).

As shown in FIG. 11A, although an image should originally be displayed at the brightness of Lmax0 in the position of xmax, the arriving light brightness value in xmax is Lmax and therefore an image cannot be displayed at the brightness of Lmax0. Hence, brightness signal correcting section 4402 corrects the input brightness value of the pixel in the position of xmax such that the display brightness value of the pixel in the position of xmax is Lmax. Further, brightness signal correcting section 4402 also corrects input brightness values in the surrounding pixels according to the operation of correcting this xmax. That is, brightness signal correcting section 4402 corrects the input brightness value such that light emission brightness characteristics 1101 based on the original input brightness value become light emission brightness characteristics 1102. To be more specific, regarding pixels with the original input brightness value equal to or more than L1 and less than Lmax0, brightness signal correcting section 4402 corrects input brightness values such that display brightness values smoothly change keeping gradation even in the highlighted portion. Further, regarding pixels with the original input brightness value less than L1, brightness signal correcting section 4402 corrects input brightness values in a conventional manner, and outputs the results.

FIG. 11B is a conceptual diagram for illustrating a second example of the correcting operation in brightness signal correcting section 702.

As shown in FIG. 11B, although an image should originally be displayed at the brightness of Lmax0 in the position of xmax, the arriving light brightness value in xmax is Lmax and therefore an image cannot be displayed at the brightness of Lmax0. Hence, brightness signal correcting section 4402 corrects the input brightness value of the pixel in the position of xmax such that the display brightness value of the pixel in the position of xmax is Lmax. Further, brightness signal correcting section 4402 also corrects input brightness values in the surrounding pixels according to the operation of correcting this xmax. That is, brightness signal correcting section 4402 corrects the input brightness value such that light emission brightness characteristics 1103 based on the original input brightness value become light emission brightness characteristics 1104. To be more specific, regarding pixels with the original input brightness value equal to or more than L1 and less than Lmax0, brightness signal correcting section 4402 corrects input brightness values such that display brightness values smoothly change keeping gradation even in the highlighted portion. Further, regarding pixels with the original input brightness value less than L1, brightness signal correcting section 4402 corrects input brightness values in a conventional manner, and outputs the results. Here, regarding pixels with the original input brightness value equal to or more than L1 and less than Lmax0, the input brightness value is corrected according to the operation of correcting xmax irrespective of whether or not the original brightness value exceeds the arriving light brightness value (see light emission characteristics 1105 of FIG. 11B) of these pixels.

That is, according to the above example of the correcting operation, correction to compress gradation is performed with respect to the pixels positioned around the position of xmax, according to the operation of correcting the pixel of the position of xmax. Consequently, it is possible to maintain the local contrast in the highlighted portion. As long as the input brightness values of surrounding pixels are L1 or more, even if they go below the arriving light brightness value of these surrounding pixels, correction to compress gradation is performed according to the operation of correcting the pixel in the position of xmax. By this means, it is possible to reduce the degree of compression of gradation in each pixel, and display more natural images.

<1-1-4-4-2-1. Specific Correcting Method in Brightness Correcting Section>

Hereinafter, a specific correcting method in brightness signal correcting section 4402 will be explained with reference to the accompanying drawings. Here, an input brightness value in a corrected pixel is set to Dc, a peak brightness value in the pixel is set to Dmax, an arriving light brightness value is set to D0 and the original input brightness value is set to D. Brightness signal correcting section 4402 corrects input brightness value D to input brightness value Dc based on arriving light brightness value D0 and peak brightness value Dmax. Note that the following correcting method is effective in case where peak brightness value Dmax is greater than arriving light brightness value D0. In other words, the following correcting method is effective in case where, although the brightness value of Dmax is required from a certain image signal, the brightness value of light arriving at this pixel is smaller than Dmax, and therefore there is a possibility that gradation characteristics break as a result and the brightness value is saturated. Particularly, regarding multiple low brightness portions distributed in an actual image signal, it is possible to keep gradation characteristics set in this image signal and compensate for gradation characteristics in the highlighted portions.

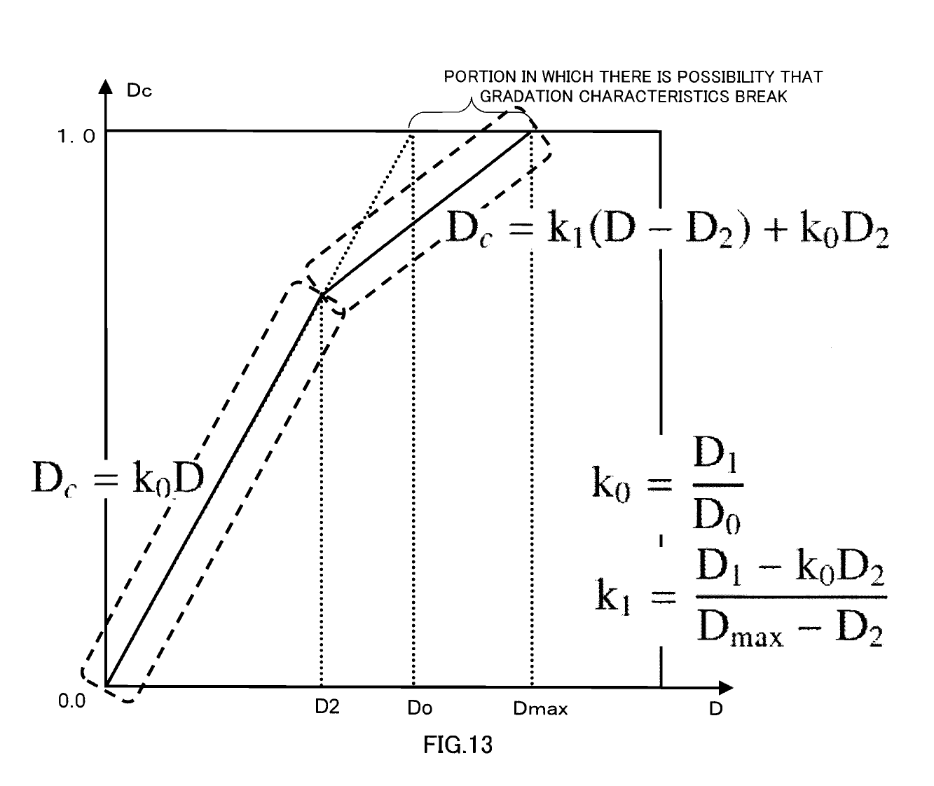

FIG. 13 illustrates a specific correcting method in brightness signal correcting section 4402.

In FIG. 13, the x axis is original input brightness value D defined in the image signal, and the y axis is the corrected input brightness value. Further, brightness value D1 in FIG. 13 is the maximum value produced as the corrected input brightness value, and is 1.0 here.

D2 in FIG. 13 is the value set in advance by the architect, and, from this setting value, a correction coefficient (also referred to as “change ratio” with the following embodiment) used to correct input brightness value D of the pixel of interest is changed. For ease of explanation, this setting value is referred to as “correction coefficient change point.” Correction coefficient change point D2 may be any value such as a value of 70 percent of arriving light brightness value D0 as long as it is smaller than arriving light brightness value D0. Note that gradation characteristics on the highlighted side break when correction coefficient change point D2 becomes closer to arriving light brightness value D0. Therefore, in case where it is preferable to keep gradation characteristics on the highlighted side, the interval between arriving light brightness value D0 and correction coefficient change point D2 is set longer. By contrast with this, in case where it is preferable to keep gradation characteristics on the dark side, correction coefficient change point D2 is set closer to arriving light brightness value D0. With the present embodiment, the value of correction coefficient change point D2 is set to 70 percent of arriving light brightness value D0.

First, based on arriving light brightness value D0 of the pixel that is the target to correct (that is, the pixel of interest), correction characteristics that define corrected input brightness value Dc are determined for original input brightness value D having a value in the range between 0.0 and D2. These correction characteristics are represented by a straight line with a relatively large inclination on the graph as shown in FIG. 13, and are represented by following equation 1 as a mathematical formula. k0 is the correction coefficient.

$$\begin{matrix}( Equation 1 ) & \\ {D}_{c} = {k}_{0} D , \\ where \\ {k}_{0} = \frac{{D}_{1}}{{D}_{0}} & [ 1 ]\end{matrix}$$

Next, based on peak brightness value Dmax of the pixel of interest, correction coefficient change point D2 and equation 1, correction characteristics that define corrected input brightness value Dc are determined for original input brightness value D in the range between D2 to Dmax. These correction characteristics are represented by a straight line with a relatively small inclination on the graph as shown in FIG. 13, and are represented by following equation 2 as a mathematical formula. k1 is the correction coefficient.

$$\begin{matrix}( Equation 2 ) & \\ {D}_{c} = {k}_{1} ( D - {D}_{2} ) + {k}_{0} {D}_{2} \\ where \\ {k}_{1} = \frac{{D}_{1} - {k}_{0} {D}_{2}}{{D}_{max} - {D}_{2}} & [ 2 ]\end{matrix}$$

Next, by substituting original input brightness value D in equation 1 or equation 2, depending on which one of D and D2 is larger, corrected input brightness value Dc is calculated.

To be more specific, in case where original input brightness value D is a value between 0.0 and D2, corrected input brightness value Dc is calculated by substituting D in equation 1. Further, in case where original input brightness value D is a value between D2 and Dmax, corrected input brightness value Dc is calculated by substituting D in equation 2.

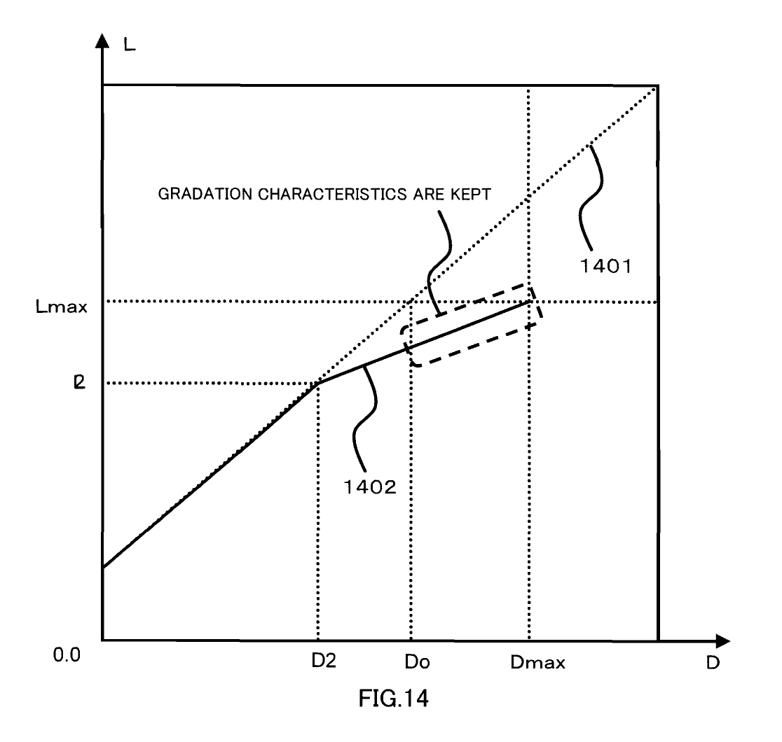

FIG. 14 shows the relationship between the original input brightness value and an actual light emission brightness value (that is, display brightness value) in a pixel of a liquid crystal panel. This relationship is acquired as a result of performing the above-described correction explained using FIG. 13.

As shown in FIG. 14, for the original input brightness value between 0.0 and D2, it is possible to display an image while keeping gradation characteristics as is, and, for the original input brightness value between D2 and Dmax, it is possible to display an image while keeping compressed gradation characteristics.

If the original input brightness value of the input image signal is applied as is and the transmittance of pixels is controlled, light emission brightness characteristics 1401 in FIG. 14 are acquired in calculation from the input brightness that is D2 or more. However, in reality, there is a possibility that gradation characteristics break at the brightness of Lmax and the display brightness is saturated. By contrast with this, with the present embodiment, light emission characteristics 1402 are realized for the input brightness value of D2 or more. Consequently, it is possible to keep gradation characteristics and reliably prevent the display brightness from being saturated.

<1-2. Conclusion>

As described above, according to the present embodiment, it is possible to calculate a peak brightness value of each pixel based on the input brightness value of each pixel, and correct the input brightness value using this peak brightness value, the input brightness value and the arriving light brightness value, while keeping the gradation characteristics on the highlighted side. By this means, it is possible to set an adequate brightness value per pixel when the input brightness value is corrected, and, consequently, display high-quality images compared to conventional display apparatuses even in case where light emission of the backlight section is controlled per area.

### Embodiment 2

Hereinafter, Embodiment 2 of the present invention will be explained. With Embodiment 1, the image correcting section keeps gradation characteristics on the highlighted side by changing correction characteristics of an input brightness value in case where the input brightness value is in the range between 0.0 and D2 and in case where the input brightness value is in the range between D2 and Dmax. However, when the input brightness value of the pixel of interest is corrected, if gradation characteristics are kept in case where the average brightness in the surrounding is low, the display brightness values become small on the whole and an entire image displayed on the liquid panel becomes dark.

Hence, with the present embodiment, when correcting an input brightness value in the image correcting section, the operation of correcting the input brightness value of the pixel of interest is changed, according to the average value in the surrounding of the pixel of interest that can be generated based on the peak brightness value per pixel which is calculated from the input brightness value.

With the above configuration, it is possible to change the operation of correcting the input brightness value taking into account the brightness characteristics in the surrounding and, consequently, express more natural gradation characteristics.

Note that the difference from the liquid crystal display apparatus according to Embodiment 1 is that processing of correcting brightness signals in the image correcting section uses the average value that can be generated using peak brightness values of the pixels in the surrounding of the pixel of interest.

Note that, with the present embodiment, the same components explained in Embodiment 1 will be assigned the same reference numerals, and will not be explained in detail.

Hereinafter, the difference of the liquid crystal display apparatus according to the present embodiment will be mainly explained with reference to the accompanying drawings.

<2-1. Image Correcting Section>

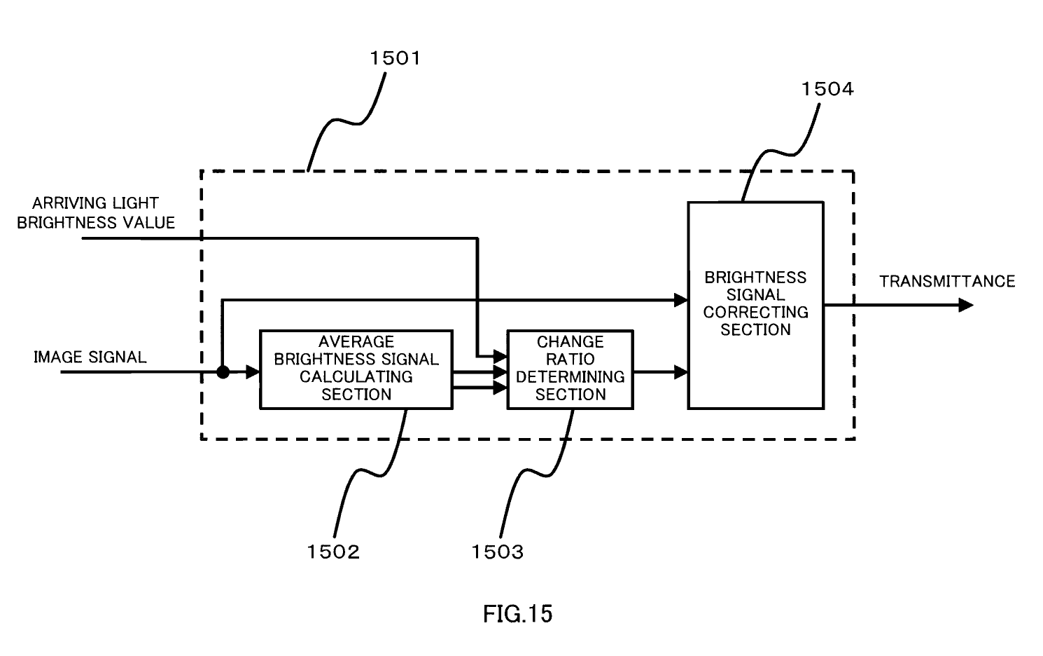

FIG. 15 is a schematic diagram showing a configuration of image correcting section 1501.

Image correcting section 1501 has average brightness signal calculating section 1502, change ratio determining section 1503 and brightness signal correcting section 1504.

<2-1-1. Average Brightness Signal Calculating Section>

Average brightness signal calculating section 1502 calculates peak brightness value Dmax of each pixel according to the same method explained in Embodiment 1. Further, average brightness signal calculating section 1502 outputs a peak brightness signal indicating calculated peak brightness value Dmax, to change ratio determining section 1503. Furthermore, average brightness signal calculating section 1502 calculates, per pixel, average value Dave in an area (hereinafter “averaging area”) including the pixel and its surrounding pixels, based on peak brightness value Dmax of each pixel. Still further, average brightness signal calculating section 1502 outputs an average brightness signal indicating calculated average value Dave, to change ratio determining section 1503.

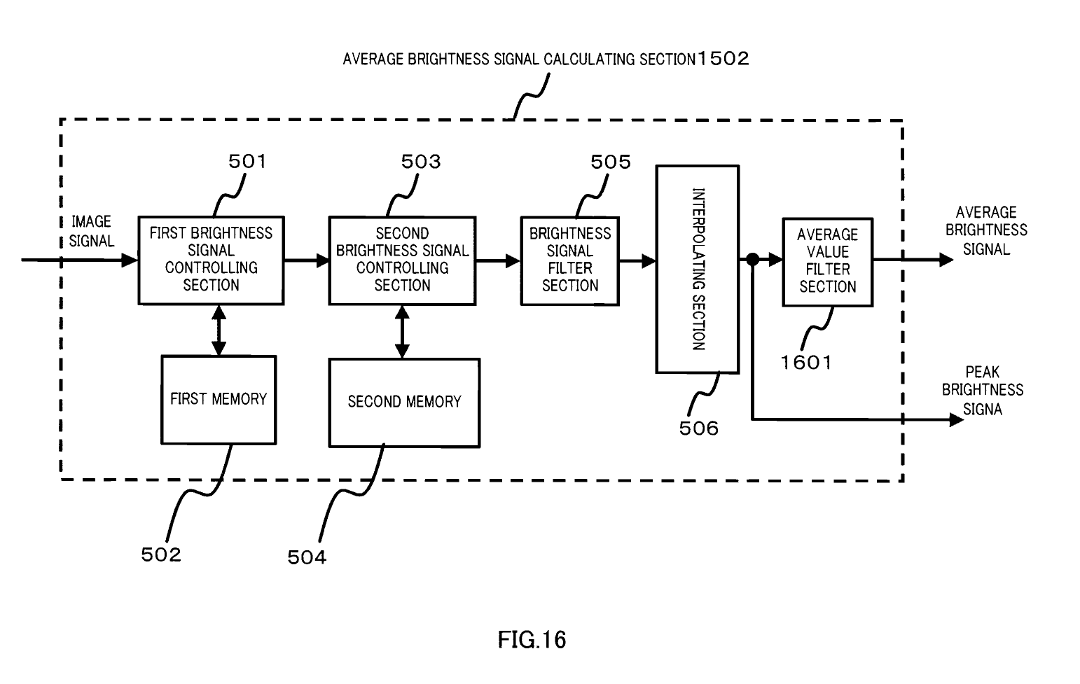

FIG. 16 is a schematic diagram showing a specific configuration of average brightness signal calculating section 1502. Average brightness signal calculating section 1502 has average value filter section 1601 in addition to the configuration of peak brightness signal calculating section 4401.

<2-1-1-1. Average Value Filter Section>

Average value filter section 1601 calculates average value Dave based on peak brightness values of peak brightness signals received as input from interpolating section 506, and outputs an average brightness signal indicating the calculated average value Dave.

Hereinafter, the method of calculating average value Dave will be explained with reference to the accompanying drawings.

<2-1-1-1-1. Method of Calculating Average Value Dave>

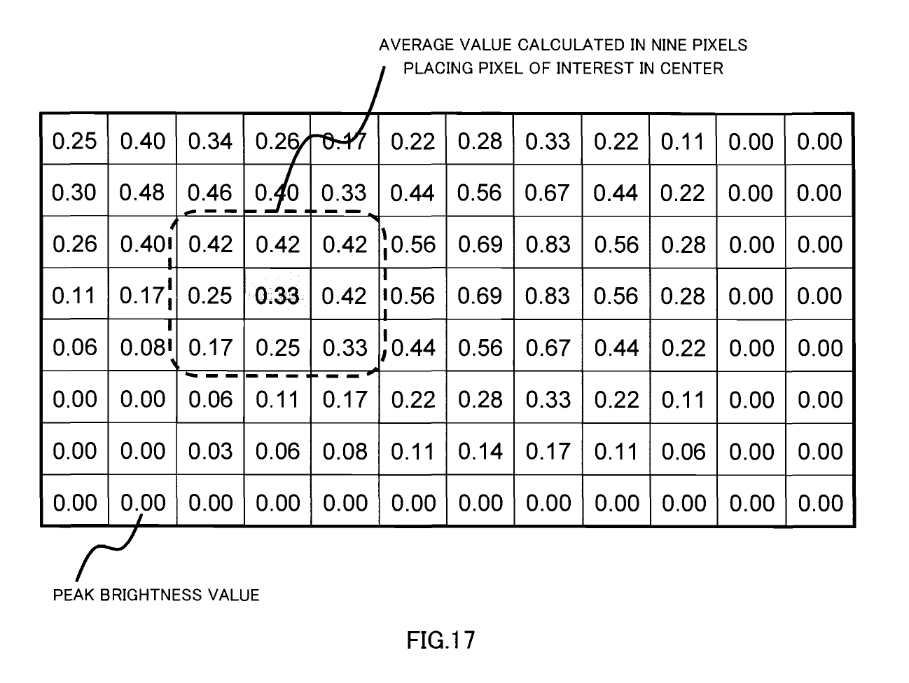

FIG. 17 illustrates a method of calculating average value Dave based on peak brightness value Dmax of each pixel. As shown in FIG. 17, the averaging area for the pixel of interest (i.e. the position in the fourth row and the fourth column in FIG. 17) is set to the area of nine pixels (pixels in the range of three rows and three columns) around the pixel of interest. The averaging area is set per pixel.

Note that the size of three rows and three columns of the averaging area shown in FIG. 17 is one example, and a wider averaging area may be set. Further, the number of pixels in the averaging area, the difference in brightness between pixels and the like may be taken into account. Further, in case where a liquid crystal panel having a sufficient number of pixels is used, it is possible to appropriately set the area of 100 rows and 100 columns at maximum as the averaging area.

<2-1-2. Change Ratio Determining Section>

Change ratio determining section 1503 calculates per pixel the change ratio used in brightness signal correcting section 1504, based on the average value, peak brightness value and arriving light brightness value. Further, change ratio determining section 1503 outputs the change ratio calculated per pixel, to brightness signal correcting section 1504.

<2-1-2-1. Operation in Change Ratio Determining Section>

Next, the method of determining the change ratio in change ratio determining section 1503 will be explained with reference to the accompanying drawings.

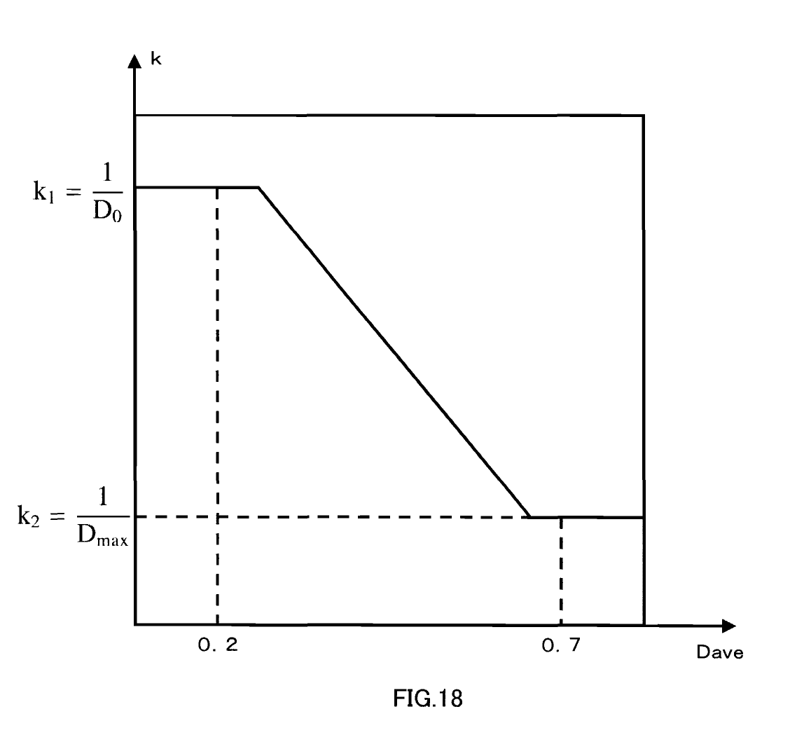

FIG. 18 shows the relationship between the average value and the change ratio. The peak brightness value in the pixel is set to Dmax, the arriving light brightness value in this pixel is set to D0 and the change ratio is set to k.

As shown in FIG. 18, in case where average value Dave is large, the change ratio is set such that gradation characteristics appear up to an input brightness value equal to peak brightness value Dmax. Further, in case where average value Dave is small, the change ratio is set such that gradation characteristics appear up to an input brightness value equal to arriving light brightness value D0. Further, in case where the average value is the above intermediate value, the change ratio is set such that gradation characteristics change continuously. For example, in case where the average value is large (for example, 0.7), the value of change ratio k is k2. Further, in case where the average value is small (for example, 0.2), the value of change ratio k is k1.

<2-1-3. Brightness Signal Correcting Section>

Brightness signal correcting section 1504 corrects the input brightness value based on the arriving light brightness value, the input brightness value and change ratio k.

<2-1-3-1. Correcting Method in Brightness Signal Correcting Section>

Hereinafter, the correcting method in brightness signal correcting section 1504 will be explained with reference to the accompanying drawings.

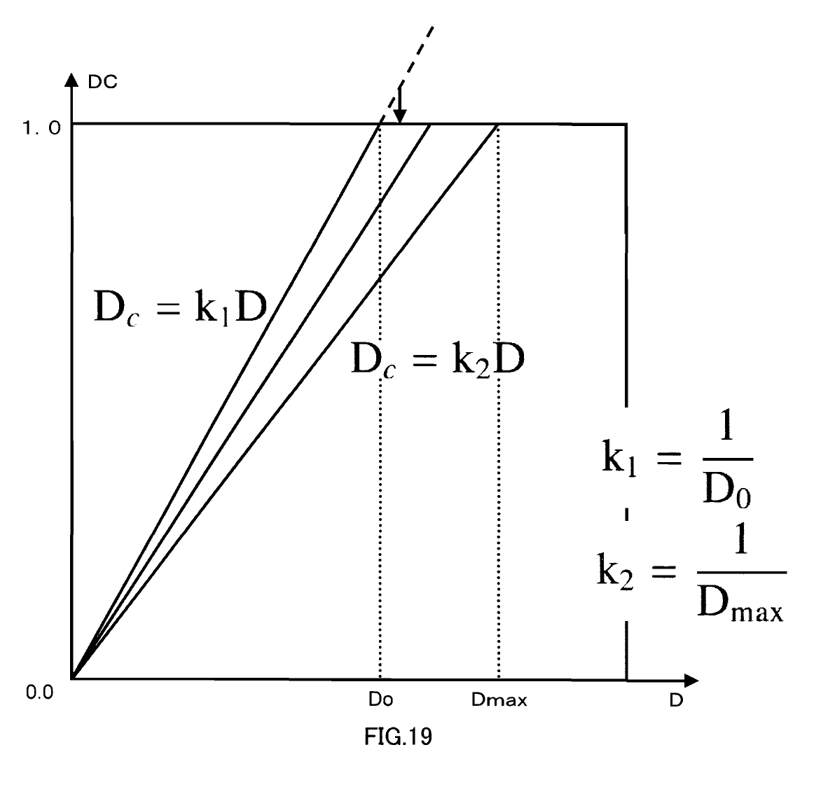

FIG. 19 illustrates a specific correcting method in brightness signal correcting section 1504. Here, the corrected input brightness value is set to Dc and the original input brightness value is set to D. Brightness signal correcting section 1504 corrects input brightness value D to input brightness value Dc based on correction characteristics defined based on change ratio k.

First, brightness signal correcting section 1504 calculates correction characteristics that define corrected input brightness value Dc, for original input brightness value D having a value in the range between 0.0 and D2 based on change ratio k defined in the pixel of the target to correct (that is, the pixel of interest). These correction characteristics are represented by following equation 3 as a mathematical formula, and are represented on the graph by a straight line with a varying inclination according to change ratio k as shown in FIG. 19.

(Equation 3)

D_{c}=kD [3]

Next, by substituting original input brightness value D in equation 3, corrected input brightness value Dc is calculated. Note that, in case where the value of calculated corrected input brightness value Dc exceeds 1.0, corrected input brightness value Dc is always reset to 1.0.

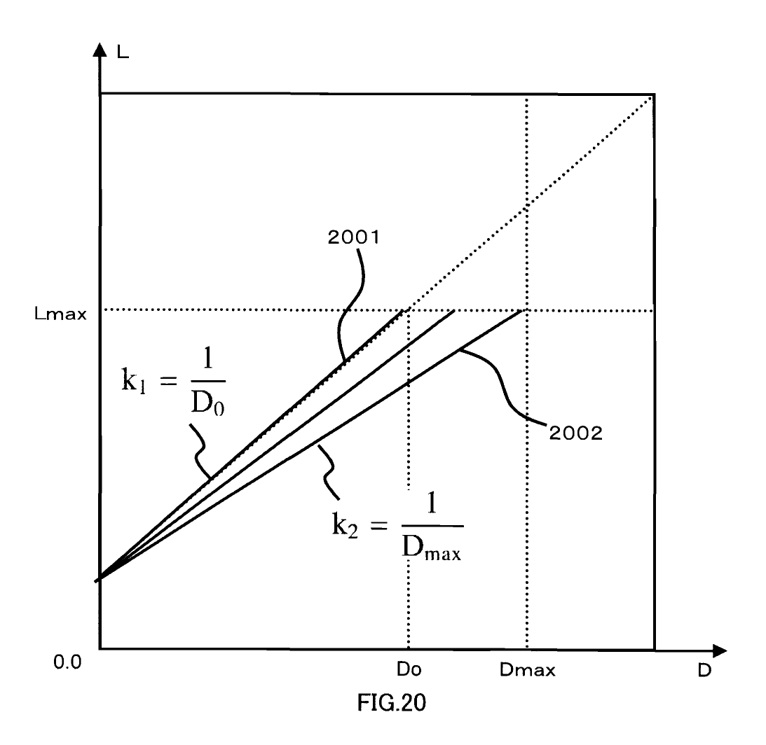

FIG. 20 shows the relationship between the original input brightness value and an actual light emission brightness value (that is, display brightness value) in a pixel of the liquid crystal panel. This relationship is acquired as a result of performing the above correction explained using FIG. 19.

As shown in FIG. 20, regarding pixels of a large average value, it is possible to set a display brightness value such that gradation can be represented continuously up to input brightness value D equal to peak brightness value Dmax. However, in any pixel, the actual display brightness value becomes smaller than a target display brightness value based on the original input brightness value. This is because gradation characteristics on the highlighted side are kept instead of setting a display brightness value smaller. Further, regarding pixels of a small average value, it is possible to set a display brightness value while keeping gradation characteristics up to input brightness value D equal to arriving light brightness value D0. Moreover, even if display at the brightness of Lmax or more from the input brightness value is demanded, the light emission brightness value cannot be set larger than 1.0, and therefore the display brightness value is saturated. This is because, instead of sacrificing gradation characteristics on the highlighted side, gradation characteristics in the dark portion are set the same as defined for the input image value.

That is, in case where the average value in the averaging area for the pixel of interest is small, light emission brightness characteristics realized for this pixel of interest are light emission characteristics 2001 represented by a straight light with a relatively large inclination in FIG. 20. By contrast with this, in case where the average value in the averaging area for the pixel of interest, light emission characteristics realized for this pixel of interest are light emission characteristics 2002 represented by a straight line with a relatively small inclination in FIG. 20. That is, if the input brightness value of the pixel of interest is large in a situation in which the average value is small, although there is a possibility that the display brightness is saturated, the surrounding pixels are dark, so that it is possible to keep local contrast of an image in this area. Further, the degree of compression of gradation characteristics is alleviated (or the gradation characteristics are not compressed) in a situation in which the average value is small, so that it is possible to prevent an entire image from being dark even if the input brightness value of the pixel of interest is small.

<2-2. Conclusion>

As described above, according to the present embodiment, it is possible to calculate the average value in the averaging area from the peak brightness value of each pixel, calculate the change ratio for correcting the input brightness value based on this average value and calculate the corrected input brightness value using the change ratio. By this means, it is possible to correct an input brightness value taking into account the peak brightness value in a local area including the pixel of interest and surrounding pixels when the input brightness value is corrected, and, consequently, keep gradation characteristics on the highlighted side and correct the input brightness value.

### Embodiment 3

Hereinafter, Embodiment 3 of the present invention will be explained. Average brightness calculating section 1502 explained in Embodiment 2 employs a configuration calculating an average value of peak brightness values. However, in case where the average value of peak brightness values is taken into account, in a situation in which, for example, only one pixel inside light emitting area 22 has a higher brightness value than surrounding pixels, it is not easy to optimize all light emitting areas 22.

Hence, with the present embodiment, an average brightness signal calculating section changes the operation of correcting an input brightness value according to the average value of input brightness values, not the average value of peak brightness values.

With the above configuration, it is possible to, for example, change the operation of correcting the input brightness value taking into account brightness characteristics in the surrounding, and, consequently, express gradation characteristics that optimize brightness values in the entire liquid crystal panel.

Note that the difference from the liquid crystal display apparatus according to Embodiment 2 is that the image correcting section has average value filter section 1601 instead of an average brightness signal calculating section.

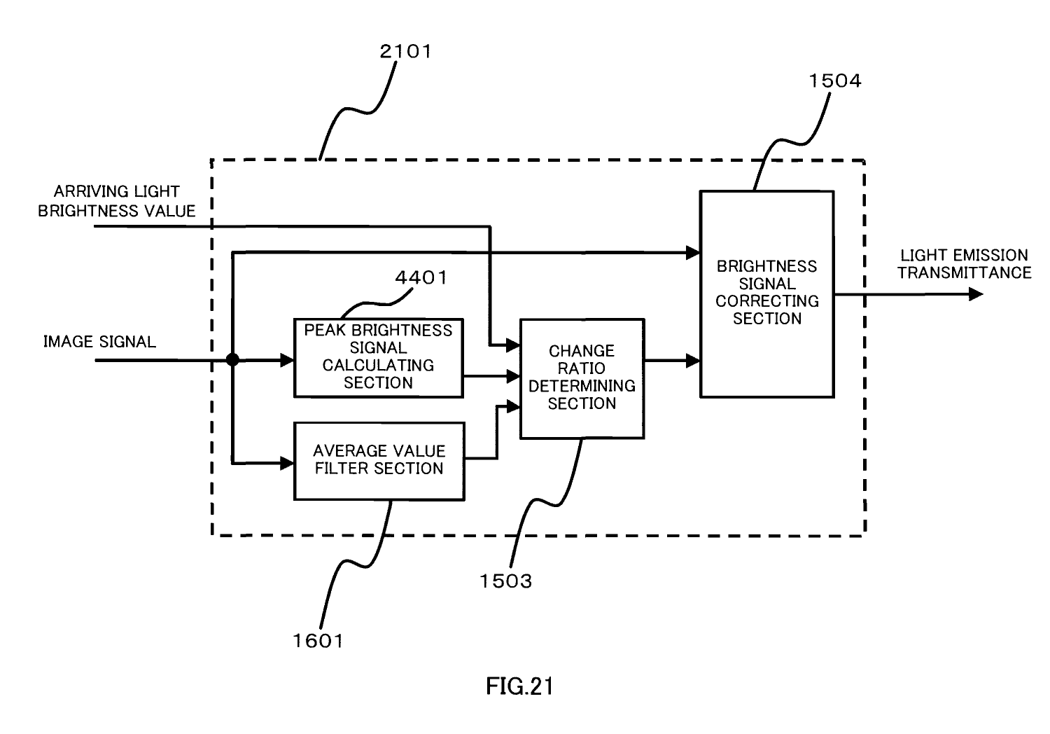

FIG. 21 shows a configuration of image correcting section 2101 according to the present embodiment. Average value filter section 1601 calculates, per pixel, average value Dave in the averaging area (for example, see FIG. 17) set per pixel, based on input brightness value D of each pixel instead of peak brightness value Dmax of each pixel. Average value filter section 1601 outputs an average brightness signal indicating calculated average value Dave to change ratio determining section 1503. Other components in the liquid crystal display apparatus according to the present embodiment are the same as in Embodiments 1 and 2, and will not be explained in detail.

As described above, according to the present embodiment, it is possible to calculate an average value in an averaging area taking into account input brightness values of surrounding pixels, based on the input brightness value of each pixel. Further, based on this average value, it is possible to calculate the change ratio for correcting an input brightness value and calculate the corrected input brightness value using this change ratio. By this means, it is possible to correct an input brightness value taking into account input brightness values in a local area including the pixel of interest and its surrounding pixels when the input brightness values are corrected, and, consequently, correct the input brightness values to optimize entire liquid crystal panel 10.

### Another Embodiment

Hereinafter, another embodiment will be explained.

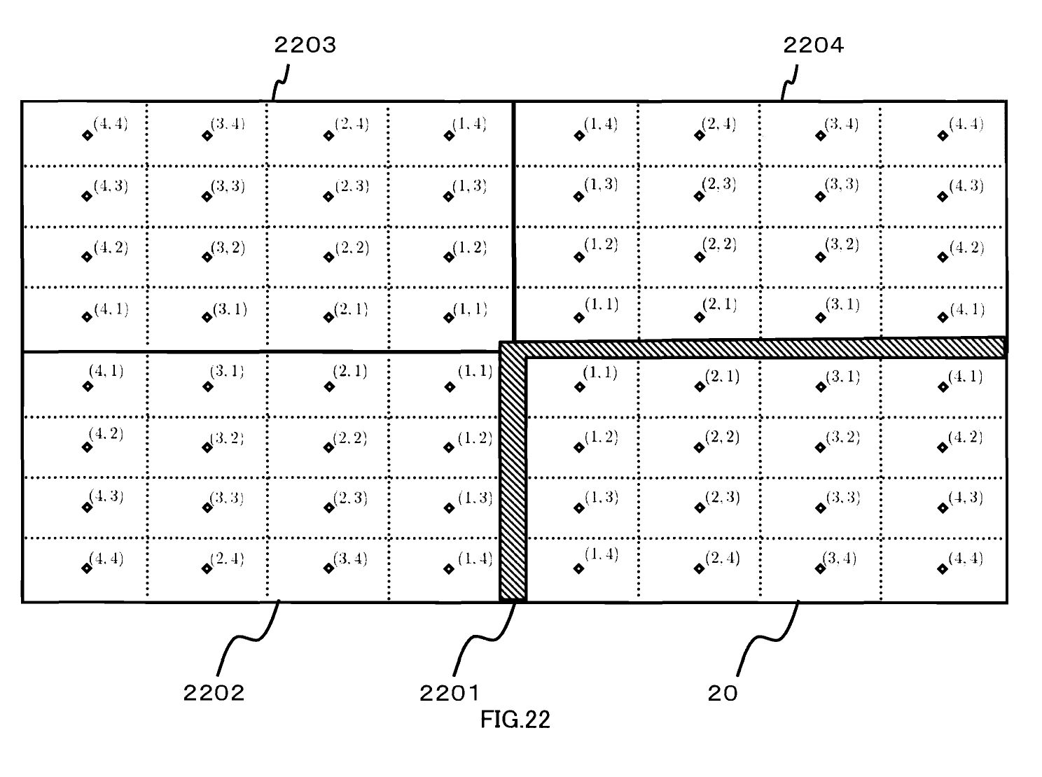

In Embodiments 1 to 3, a configuration is possible where reflecting plate 2201 that reflects illumination light from virtual light sources 23 is provided in the lateral surface part of backlight section 20. FIG. 22 shows a configuration in which reflecting plate 2201 is provided in backlight section 20. In case where reflecting plate 2201 is provided in backlight section 20, backlight section 20 operates as if it is virtually expanded. That is, a configuration is provided in which virtual backlight sections 2202, 2203 and 2204 are provided around backlight section 20.

In this case, filter processing is performed in the same way with respect to backlight sections 2202, 2203 and 2204 that are virtually set.

With the above configuration, it is possible to calculate a peak brightness value and an average value in a pixel of interest more accurately.

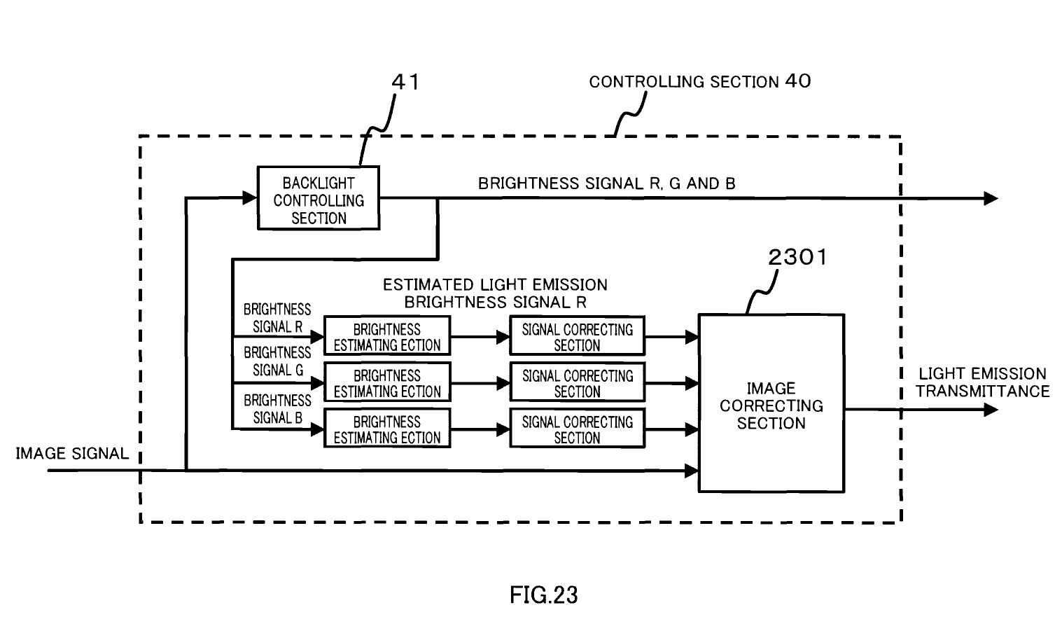

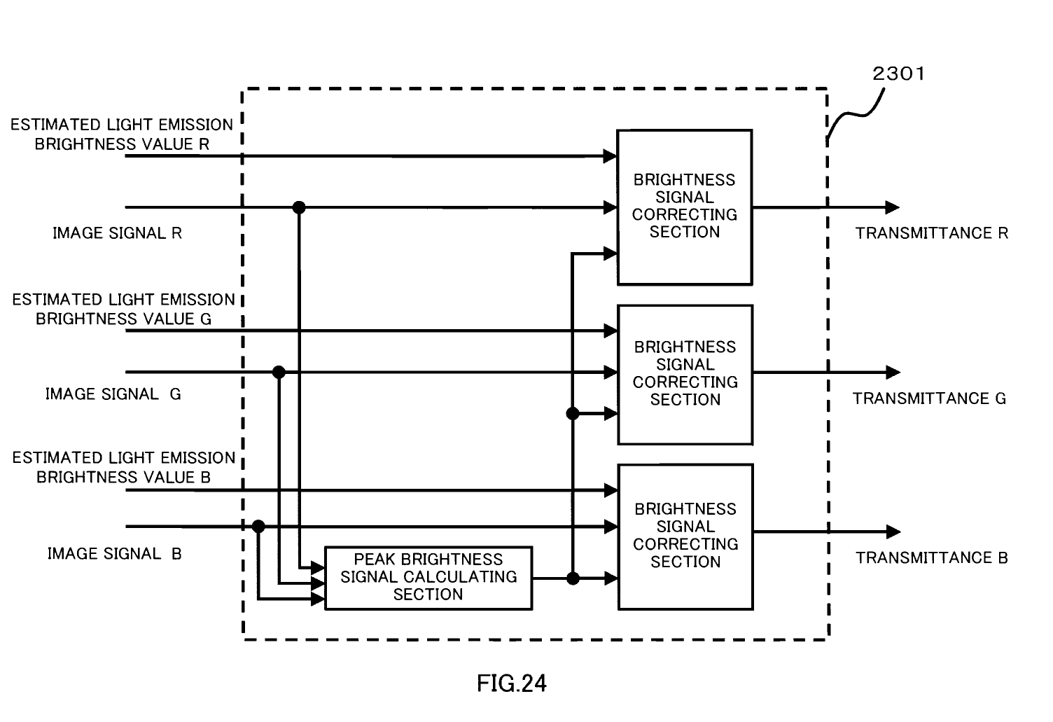

Further, as described in Embodiment 1, although light source 21 may emit white light by blending red, green and blue lights, the same applies to Embodiments 2 and 3. In this case, a configuration is also possible where light emission brightnesses of red, green and blue can be individually controlled. FIG. 23 shows a configuration of a controlling section of a liquid crystal display apparatus with a backlight that can control red, green and blue independently. Backlight controlling section 41 outputs brightness signals corresponding to red, green and blue. In the brightness estimating section and the signal correcting section, three systems supporting red, green and blue are provided. With this configuration, arriving light brightness values for red, green and blue are calculated. With the above configuration, it is possible to calculate an arriving light brightness value in a pixel of interest more accurately even in case where light emission brightnesses of red, green and blue can be controlled independently. Further, FIG. 24 shows a specific configuration of image correcting section 2301 of FIG. 23. In case where red, green and blue are independently controlled, the peak brightness signal calculating section receives as input the arriving light brightness values generated from red, green and blue signals, and determine the peak brightness value. Further, the brightness signal correcting section independently controls red, green and blue based on the generated peak brightness value.

Further, it is equally possible to mutually combine above Embodiments 1 to 3 for use. Furthermore, it is also possible to combine another embodiment with Embodiments 1 to 3 for use.

### INDUSTRIAL APPLICABILITY

The image display apparatus according to the present invention can display high-quality images, and therefore is useful as an image display apparatus such as a PC monitor or digital TV.

### REFERENCE SIGNS LIST

10 LIQUID CRYSTAL PANEL
20 BACKLIGHT SECTION
21 LIGHT SOURCE
22 LIGHT EMITTING AREA
23 VIRTUAL LIGHT SOURCE
30 BACKLIGHT DRIVER
40 CONTROLLING SECTION
41 BACKLIGHT CONTROLLING SECTION
42 BRIGHTNESS ESTIMATING SECTION
43 SIGNAL CORRECTING SECTION
44, 1501, 2101, 2301 IMAGE CORRECTING SECTION
501 FIRST BRIGHTNESS SIGNAL CONTROLLING SECTION
502 FIRST MEMORY
503 SECOND BRIGHTNESS SIGNAL CONTROLLING SECTION
504 SECOND MEMORY
505 BRIGHTNESS SIGNAL FILTER SECTION
506 INTERPOLATING SECTION
801 SUBBLOCK
1001, 1102, 1103, 1104, 1105, 2001, 2002 LIGHT EMISSION BRIGHTNESS CHARACTERISTICS
1201 ROW
1401, 1402 GRADATION CHARACTERISTICS
1502 AVERAGE BRIGHTNESS SIGNAL CALCULATING SECTION
1503 CHANGE RATIO DETERMINING SECTION
1504, 4402 BRIGHTNESS SIGNAL CORRECTING SECTION
1601 AVERAGE VALUE FILTER SECTION
2201 REFLECTING PLATE
2202, 2203, 2204 VIRTUAL BACKLIGHT SECTION
4401 PEAK BRIGHTNESS SIGNAL CALCULATING SECTION

1. An image display apparatus comprising:
a light source which comprises a plurality of light sources disposed such that a plurality of light emitting areas are formed and in which a light emission brightness value is controlled per each light emitting area;
a display section which displays an image by modulating light from the light source section according to a modulation factor corresponding to a brightness value of an input image signal;
an acquiring section which acquires an arriving light brightness signal indicating a brightness value of light arriving at a pixel of interest in the display section; and
a controlling section which controls the image display apparatus,
wherein the controlling section calculates a modulation factor corresponding to a brightness value of an input image signal for the pixel of interest, based on input image signals for the pixel of interest and surrounding pixels of the pixel of interest and the acquired arriving light brightness signal.

2. The image display apparatus according to claim 1, wherein, based on brightness values of input image signals for a plurality of pixels in the display section comprising the pixel of interest and the surrounding pixels of the pixel of interest, the controlling section generates a peak brightness signal indicating a peak brightness value per pixel and calculates the modulation factor based on the generated peak brightness signal.

3. The image display apparatus according to claim 1, wherein:
the controlling section calculates the modulation factor using varying correction coefficients depending on which one of a reference brightness value and the brightness value of the input image signal for the pixel of interest is larger; and
the reference brightness value is set in advance to a value smaller than a brightness value of the acquired arriving light brightness signal.

4. The image display apparatus according to claim 1, wherein the controlling section generates a peak brightness signal indicating a peak brightness value, per pixel based on brightness values of input image signals for a plurality of pixels in the display section comprising the pixel of interest and the surrounding pixels of the pixel of interest, calculates an average value of peak brightness values of the generated peak brightness signals per averaging area set for the plurality of pixels, and calculates the modulation factor based on an average value in the averaging area set with respect to the pixel of interest.

5. The image display apparatus according to claim 1, wherein the controlling section calculates an average value of brightness values of input image signals for a plurality of pixels in the display section comprising the pixel of interest and surrounding pixels of the pixel of interest, per averaging area set for the plurality of pixels, and calculates the modulation factor based on an average value in the averaging area set with respect to the pixel of interest.

6. A controlling apparatus that controls an image display apparatus which displays an image by modulating light from a light source section which comprises a plurality of light sources disposed such that a plurality of light emitting areas are formed and in which a light emission brightness value is controlled per light emitting area, according to a modulation factor corresponding to a brightness value of an input image signal, the controlling apparatus comprising:
an acquiring section which acquires an arriving light brightness signal indicating a brightness value of light arriving at a pixel of interest in the display section; and
a controlling section which calculates a modulation factor corresponding to the brightness value of the input image signal for the pixel of interest, based on input image signals for the pixel of interest and surrounding pixels of the pixel of interest and the acquired arriving light brightness signal.
